(19) United States
(12) Patent Application Publication
(10) Pub. No.: US 2015/0341441 A1
(43) Pub. Date: Nov. 26, 2015

(54) INFORMATION PROCESSING SYSTEM AND INFORMATION PROCESSING APPARATUS

(71) Applicants: Hirohisa SAITOH, Tokyo (JP); Tomohiro Kuroyanagi, Kanagawa (JP); Tohru Sasaki, Kanagawa (JP); Atsushi Okazato, Kanagawa (JP); Makoto Sasaki, Kanagawa (JP); Junki Aoki, Kanagawa (JP); Takuya Mori, Tokyo (JP); Mie Watanabe, Tokyo (JP); Tatsuo Nishimura, Tokyo (JP); Yukinori Ishii, Kanagawa (JP); Yasunori Tsukioka, Kanagawa (JP); Shunsuke Watanabe, Tokyo (JP); Hiroyuki Sakuyama, Tokyo (JP); Yuka Konno, Kanagawa (JP); Katsumi Tanaka, Kanagawa (JP); Takashi Toriumi, Kanagawa (JP)

(72) Inventors: Hirohisa SAITOH, Tokyo (JP); Tomohiro Kuroyanagi, Kanagawa (JP); Tohru Sasaki, Kanagawa (JP); Atsushi Okazato, Kanagawa (JP); Makoto Sasaki, Kanagawa (JP); Junki Aoki, Kanagawa (JP); Takuya Mori, Tokyo (JP); Mie Watanabe, Tokyo (JP); Tatsuo Nishimura, Tokyo (JP); Yukinori Ishii, Kanagawa (JP); Yasunori Tsukioka, Kanagawa (JP); Shunsuke Watanabe, Tokyo (JP); Hiroyuki Sakuyama, Tokyo (JP); Yuka Konno, Kanagawa (JP); Katsumi Tanaka, Kanagawa (JP); Takashi Toriumi, Kanagawa (JP)

(21) Appl. No.: 14/717,166

(22) Filed: May 20, 2015

(30) Foreign Application Priority Data
May 26, 2014 (JP) 2014-108135
Apr. 10, 2015 (JP) 2015-080594

(51) Int. Cl. H04L 29/08

(52) U.S. Cl. CPC H04L 67/125; H04L 67/1095

(57) ABSTRACT

An information processing system includes electronic devices each including a display unit, and at least one information processing apparatus including a display unit. The information processing apparatus is able to communicate with the electronic devices via a network. The information processing system includes a first sharing unit configured to cause sharing of display contents of the display unit of a first electronic device of the electronic devices and the display unit of the information processing apparatus; and a second sharing unit configured to acquire, from the first electronic device, information of a second electronic device of the electronic devices that is operating in cooperation with the first electronic device, and cause sharing of display contents of the display unit of the second electronic device and the display unit of the information processing apparatus based on the information of the second electronic device.

### BACKGROUND OF THE INVENTION

1. Field of the Invention

The present invention relates to an information processing system and an information processing apparatus.

2. Description of the Related Art

In a user device such as a multifunction peripheral (MFP), the user is able to send a query to the operator when the user does not know how to operate the user device, etc. There is known a remote support technology used in such a case, by which the user device and the operator terminal share a screen of the user device, and the user can receive remote support from the operator.

Conventionally, there has been a remote control system for making operations and confirmations from a remote location, with respect to an appliance terminal device of an electric home appliance. In the conventional remote control system, operations of the appliance terminal device are shared among a plurality of users at remote locations (the client, the customer, etc.), the present status and operation statuses before the present status of the appliance terminal device are shared as a three-dimensional model, and operations are smoothly made among a plurality of users (see, for example, Patent Document 1).

For example, when the screen of the user device is shared by the user device and the operator terminal, the user operating the user device checks the information for sharing the screen by the user device and the operator terminal, and reports the information to the operator of the operator terminal. The information for sharing the screen by the user device and the operator terminal is an identification code, an IP address, etc., of the user device.

Therefore, when the screen of the user device is shared by a plurality of user devices performing device cooperation and an operator terminal, the user needs to check and report the information for sharing the screen with the operator terminal, with respect to each of the plurality of user devices, which has been a great burden on the user.

Patent Document 1: Japanese Patent No. 3548065

### SUMMARY OF THE INVENTION

The present invention provides an information processing system and an information processing apparatus, in which one or more of the above-described disadvantages are eliminated.

According to an aspect of the present invention, there is provided an information processing system including a plurality of electronic devices each including a display unit, and at least one information processing apparatus including a display unit, the at least one information processing apparatus being able to communicate with the plurality of electronic devices via a network, the information processing system including a first sharing unit configured to cause sharing of display contents of the display unit of a first electronic device of the plurality of electronic devices and the display unit of the at least one information processing apparatus; and a second sharing unit configured to acquire, from the first electronic device, information of a second electronic device of the plurality of electronic devices that is operating in cooperation with the first electronic device, and cause sharing of display contents of the display unit of the second electronic device and the display unit of the at least one information processing apparatus based on the information of the second electronic device.

According to an aspect of the present invention, there is provided an information processing apparatus including a display unit, the information processing apparatus being able to communicate with a plurality of electronic devices each including a display unit via a network, the information processing apparatus including a first sharing unit configured to cause sharing of display contents of the display unit of a first electronic device of the plurality of electronic devices and the display unit of the information processing apparatus; and a second sharing unit configured to acquire, from the first electronic device, information of a second electronic device of the plurality of electronic devices that is operating in cooperation with the first electronic device, and cause sharing of display contents of the display unit of the second electronic device and the display unit of the information processing apparatus based on the information of the second electronic device.

According to an aspect of the present invention, there is provided a non-transitory computer-readable recording medium storing a program that causes a computer to execute a process performed in an information processing apparatus including a display unit, the information processing apparatus being able to communicate with a plurality of electronic devices each including a display unit via a network, the process including causing sharing of display contents of the display unit of a first electronic device of the plurality of electronic devices and the display unit of the information processing apparatus; and acquiring, from the first electronic device, information of a second electronic device of the plurality of electronic devices that is operating in cooperation with the first electronic device, and causing sharing of display contents of the display unit of the second electronic device and the display unit of the information processing apparatus based on the information of the second electronic device.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration of an example of an information processing system according to an embodiment;

FIG. 2 illustrates a hardware configuration of an example of a computer according to an embodiment;

FIG. 3 illustrates a hardware configuration of an example of a user device according to an embodiment;

FIG. 4 is a process block diagram of an example of an operator terminal according to an embodiment; FIG. 5 is a process block diagram of an example of the user device according to an embodiment;

FIG. 6 is an image diagram of an example of remote support;

FIG. 7 is an image diagram of an example of device cooperation;

FIG. 8 is a sequence diagram of an example of operations of remote support according to an embodiment;

FIG. 9 is a flowchart of an example of a process performed by the user device that is the cooperation source;

FIG. 10 illustrates an example of screen transition in the user device that is the cooperation source;

FIG. 11 is a flowchart of an example of a process performed by the operator terminal;

FIG. 12 illustrates an example of screen transition in the operator terminal;

FIG. 13 is a sequence diagram of another example of the operations of remote support according to an embodiment;

FIG. 14 is a flowchart of another example of a process performed by the operator terminal;

FIG. 15 is a sequence diagram of yet another example of the operations of remote support according to an embodiment;

FIG. 16 is a flowchart of yet another example of a process performed by the operator terminal;

FIGS. 17A and 17B illustrate a hardware configuration of other examples of a user device and an operator terminal according to an embodiment;

FIG. 18 illustrates a process block diagram of another example of the user device according to an embodiment;

FIG. 19 is a sequence diagram is a sequence diagram of another example of operations of remote support according to an embodiment;

FIG. 20 is an image diagram of an example of a screen of the user device for receiving input of an operation for executing screen sharing;

FIG. 21 is an image diagram of an example of a share reception screen indicating that a share start request has been received;

FIG. 22 is a sequence diagram of another example of operations of remote support according to an embodiment;

FIG. 23 is an image diagram of an example of a screen for having the user input an instruction to switch the remote assist;

FIGS. 24A and 24B are image diagrams of examples of execution screens for operator selection and a switch request; and

FIGS. 25A and 25B are image diagrams of examples of screens for selecting whether to approve the request from the operator terminal.

### DETAILED DESCRIPTION OF THE PREFERRED EMBODIMENTS

Next, a detailed description is given of an embodiment of the present invention. Note that in the present embodiment, a description is given of an example where the screen of the user device is shared by the user device and the operator terminal, and the user receives remote support from the operator; however, an embodiment of the present invention is not limited to names such as a user device or an operator terminal. The user and the operator are examples of operators.

### First Embodiment

### System Configuration

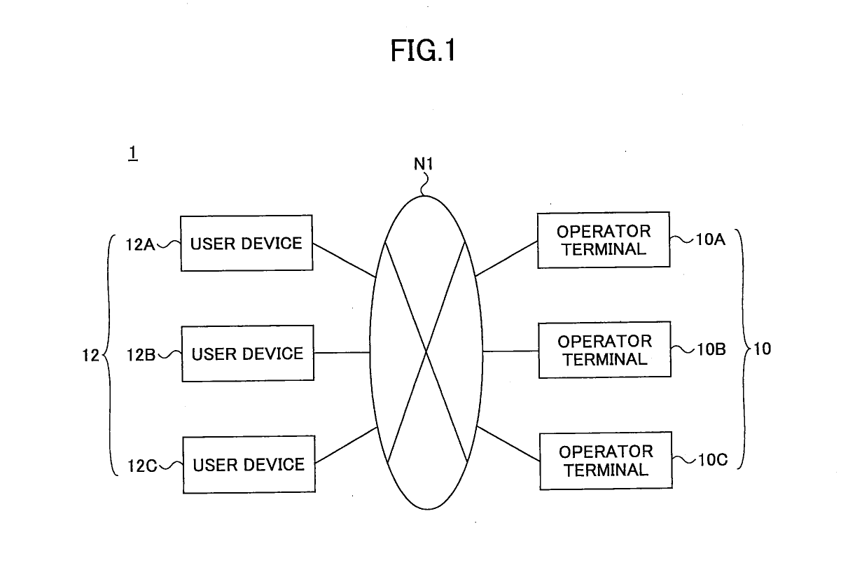

FIG. 1 illustrates a configuration of an example of an information processing system according to the present embodiment. An information processing system 1 includes operator terminals 10A through 10C and user devices 12A through 12C, which are connected via a network N1 such as a LAN or the Internet. Note that in the following, the user devices 12A through 12C may be collectively referred to as the user device 12, and the operator terminals 10A through 10C may be collectively referred to as the operator terminal 10. The operator terminal 10 and the user device 12 perform wireless or wired communication. The example of FIG. 1 indicates three operator terminals 10 and three user devices 12; however, the operator terminals 10 and the user devices 12 may be provided in other numbers.

The operator terminal 10 is operated by an operator that provides the remote support. The operator terminal 10 is realized by an information processing apparatus such as a PC (personal computer), a smartphone, a tablet terminal, etc. The user device 12 is operated by the user who receives the report support. The user device 12 is realized by an electronic device that can perform device cooperation, by performing processes in cooperation with another user device 12. The user device 12 is an electronic device that provides output data to another user device 12, an electronic device that outputs output data that has been provided from another user device 12, etc.

The electronic device that provides the output data is, for example, a reading device such as a scanner or a multifunction peripheral for reading image data from an original document and providing the image data, a storage device such as a file server device for providing a stored file, etc. The electronic device that outputs the provided output data is, for example, a printer device such as a printer or a multifunction peripheral for outputting output data such as image data and files by printing the output data, a display device such as a projector or a monitor for outputting the output data by displaying the output data, etc. The electronic device that outputs the provided output data may be a voice sound output device for outputting voice sound data by voice sound. As described above, the user device 12 may be any electronic device for outputting output data by device cooperation. Note that the configuration of the information processing system 1 of FIG. 1 is one example, the information processing system 1 may have other configurations.

### <Hardware Configuration>

<<Computer>>

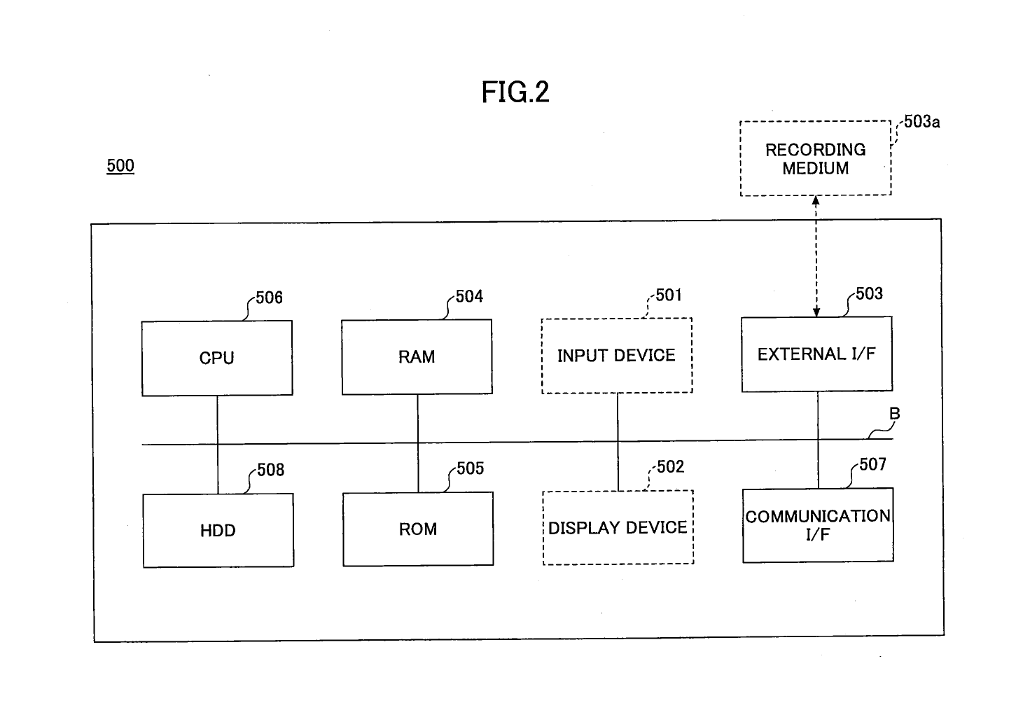

The operator terminal 10 of FIG. 1 is realized by a computer having a hardware configuration, for example, as illustrated in FIG. 2. FIG. 2 illustrates a hardware configuration of an example of a computer according to the present embodiment.

A computer 500 illustrated in FIG. 2 includes an input device 501, a display device 502, an external I/F 503, a RAM 504, a ROM 505, a CPU 506, a communication I/F 507, and a HDD 508, which are interconnected by a bus B. Note that the input device 501 and the display device 502 may have a configuration of being connected and used when necessary.

The input device 501 includes a keyboard, a mouse, and a touch panel, and is used by the user for inputting various operation signals. The display device 502 includes a display, etc., and displays processing results obtained by the computer 500.

The communication I/F 507 is an interface that connects the computer 500 to a network N1. Accordingly, the computer 500 is able to perform data communication via the communication I/F 507.

Furthermore, the HDD 508 is an example of a non-volatile storage device for storing programs and data. The stored programs and data include an OS that is the basic software for controlling the entire computer 500, and application software (hereinafter, simply referred to as “application”) for providing various functions in the OS. Note that the computer 500 may use a drive device (for example, a solid state drive: SSD) using a flash memory as the storage medium, instead of the HDD 508.

The external I/F 503 is an interface between the computer 500 and an external device. An example of the external device is a recording medium 503a. Accordingly, the computer 500 is able to read and/or write in the recording medium 503a via the external I/F 503. Examples of the recording medium 503a are a flexible disk, a CD, a DVD, an SD memory card, and a USB memory.

The ROM 505 is an example of a non-volatile semiconductor memory (storage device) that can store programs and data even after the power is turned off. The ROM 505 stores programs and data such as a BIOS that is executed when the computer 500 is activated, OS settings, and network settings. The RAM 504 is an example of a volatile semiconductor memory (storage device) for temporarily storing programs and data.

The CPU 506 is a processor for controlling the entire computer 500 and realizing functions of the computer 500, by loading the programs and data from the storage devices such as the ROM 505 and the HDD 508, into the RAM 504, and executing processes.

The operator terminal 10 according to the present embodiment is able to realize various processes described below, by the hardware configuration of the computer 500 as described above.

<<User Device>>

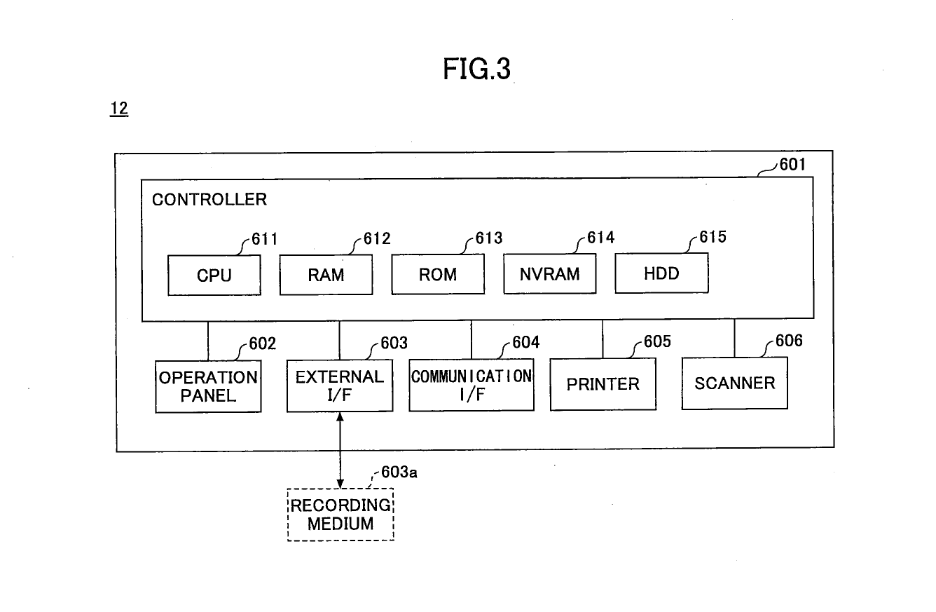

The user device 12 of FIG. 1 is realized by a hardware configuration, for example, as illustrated in FIG. 3. FIG. 3 illustrates a hardware configuration of an example of the user device 12 according to the present embodiment. The user device 12 illustrated in FIG. 3 includes a controller 601, an operation panel 602, an external I/F 603, a communication I/F 604, a printer 605, and a scanner 606.

The controller 601 includes a CPU 611, a RAM 612, a ROM 613, a NVRAM 614, and a HDD 615. The ROM 613 stores various programs and data. The RAM 612 temporarily stores programs and data. The NVRAM 614 stores, for example, setting information. Furthermore, the HDD 615 stores various programs and data.

The CPU 611 loads programs, data, setting information, etc., from the ROM 613, the NVRAM 614, the HDD 615, etc., into the RAM 612, and executes processes, to control the entire user device 12 and realize functions of the user device 12.

The operation panel 602 includes an input unit for receiving input of information from a user, and a display unit for displaying information. The external I/F 603 is an interface between the user device 12 and an external device. The external device may be a recording medium 603a. Accordingly, the user device 12 is able to perform reading and/or writing with respect to the recording medium 603a via the external I/F 603. Examples of the recording medium 603a are an IC card, a flexible disk, a CD, a DVD, an SD memory card, a USB memory, etc.

The communication I/F 604 is an interface for connecting the user device 12 to the network N1. The user device 12 can perform communication via the communication I/F 604. The printer 605 is a printing device for printing print data onto a sheet. The scanner 606 is a reading device for reading image data (electronic data) from an original document.

Note that the example of the user device 12 in FIG. 3 includes the printer 605 and the scanner 606; however, only one of the printer 605 and the scanner 606 may be included. For example, the information processing system 1 of FIG. 1, the user device 12A may include the printer 605, the user device 12B may include the printer 605 and the scanner 606, and the user device 12C may include the scanner 606.

Furthermore, the user device 12 is not limited to the configuration of FIG. 3; the user device 12 may include elements other than the printer 605 or the scanner 606, for example, when the user device 12 is a display device such as a projector or a monitor, a projecting device, and a display may be included. Furthermore, when the user device 12 is a storage device such as a file server device, the user device 12 may not include either the printer 605 or the scanner 606.

As described above, the user device 12 according to the present embodiment may be any kind of device as long as the device can perform device cooperation with one or more other user devices 12 for some purpose, share the screen of the user device 12 with the operator terminal 10, and receive remote support.

### <Software Configuration>

<<Operator Terminal>>

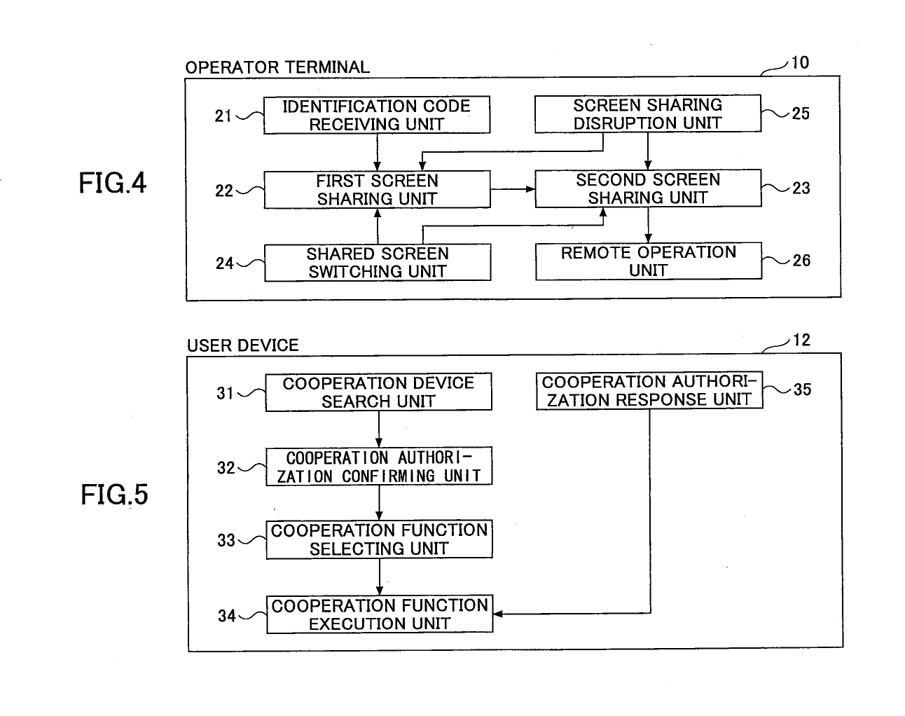

The operator terminal 10 according to the present embodiment is realized by, for example, process blocks illustrated in FIG. 4. FIG. 4 is a process block diagram of an example of the operator terminal 10 according to the present embodiment.

The operator terminal 10 realizes an identification code receiving unit 21, a first screen sharing unit 22, a second screen sharing unit 23, a shared screen switching unit 24, a screen sharing disruption unit 25, and a remote operation unit 26, by executing programs.

The identification code receiving unit 21 receives, for example, from an operator or the user device 12, input of an identification code of the user device 12 with which screen sharing is to be performed. The identification code may be any kind of information for the operator terminal 10 to perform screen sharing with the user device 12, and may be any kind of information by which the user device 12 can be uniquely identified and screen sharing can be started, such as an IP address.

The first screen sharing unit 22 performs screen sharing with the user device 12 identified by an identification code, by using the identification code received by the identification code receiving unit 21. When there is another user device 12 performing device cooperation with the user device 12 with which screen sharing is performed by the first screen sharing unit 22, the second screen sharing unit 23 performs screen sharing with the other user device 12 automatically or based on a request from the operator.

Note that the second screen sharing unit 23 acquires, from the user device 12 with which screen sharing is performed by the first screen sharing unit 22, the identification code of the other user device 12 performing device cooperation with the user device 12 with which screen sharing is performed by the first screen sharing unit 22.

The shared screen switching unit 24 switches the screen sharing by the first screen sharing unit 22 and the screen sharing by the second screen sharing unit 23 based on a request from the operator. The screen sharing disruption unit 25 disrupts (terminates) the screen sharing by the first screen sharing unit 22 or the screen sharing by the second screen sharing unit 23, based on a request from the operator.

The remote operation unit 26 performs a process of causing the other user device 12, which is performing screen sharing by the second screen sharing unit 23, to resolve an abnormality that is occurring in the other user device 12, based on a request from the operator. For example, when a communication abnormality is occurring in the other user device 12, the remote operation unit 26 performs a process of causing the other user device 12 to perform communication reset, based on a request from the operator.

<<User Device>>

The user device 12 according to the present embodiment is realized by, for example, process blocks illustrated in FIG. 5. FIG. 5 is a process block diagram of an example of the user device 12 according to the present embodiment.

The user device 12 realizes a cooperation device search unit 31, a cooperation authorization confirming unit 32, a cooperation function selecting unit 33, a cooperation function execution unit 34, and a cooperation authorization response unit 35, by executing programs such as applications.

The cooperation device search unit 31 searches for another user device (cooperation device) 12 in the network N1 when the user selects device cooperation, and causes the user to select the other user device 12 to be the cooperation destination. The cooperation authorization confirming unit 32 confirms cooperation authorization with respect to the other user device 12 selected as the cooperation destination. The cooperation authorization response unit 35 returns a cooperation authorization response to the cooperation source, when a confirmation of cooperation authorization is received from the cooperation source and device cooperation is to be authorized. Furthermore, the cooperation authorization response unit 35 reports, to the cooperation function execution unit 34, of the cooperation source for which device cooperation has been authorized. By receiving the report of the cooperation source for which device cooperation has been authorized, the cooperation function execution unit 34 of the other user device 12 that is the cooperation destination, becomes capable of implementing the cooperation function with the user device 12 that is the cooperation source.

When a cooperation authorization response is received from the other user device 12 selected as the cooperation destination, the cooperation function selecting unit 33 causes the user to select a cooperation function for cooperating with the other user device 12 that is the cooperation destination. The cooperation function execution unit 34 executes a cooperation function of cooperating with the other user device 12 that is the cooperation destination. For example, when the cooperation function is “scan to print”, the user device 12 that is the cooperation source reads the image data, and the other user device 12 that is the cooperation destination prints the image data.

### <Process Details>

<<Overview of Remote Support>>

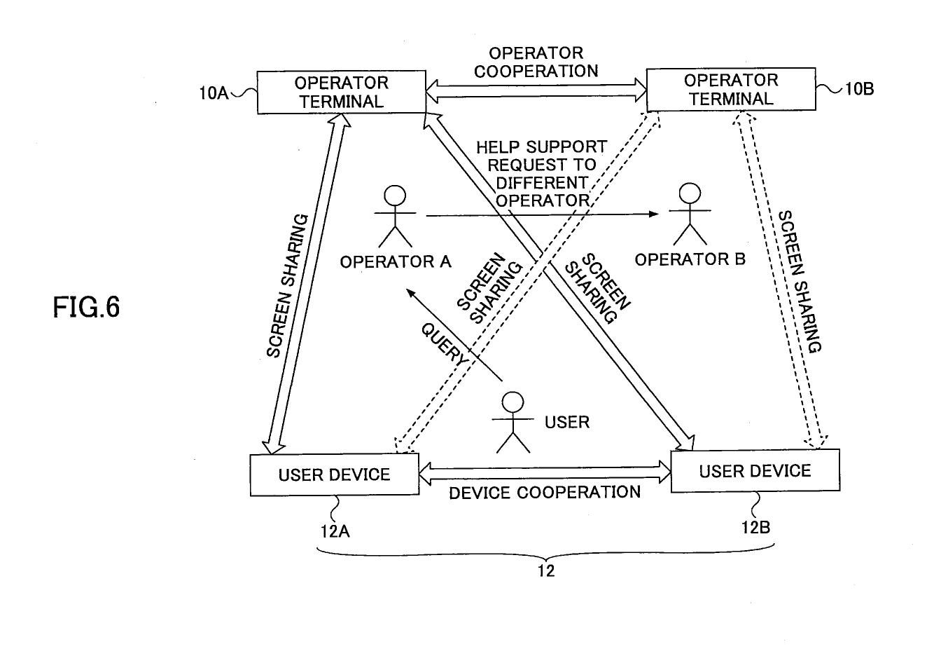

FIG. 6 is an image diagram of an example of remote support. Users, who are using user devices 12A and 12B capable of device cooperation, send a query to the operator when they do not know how to operate the user device 12 or when a problem has occurred. The query to the operator is made by a telephone call, etc.

For example, the operator who has received the query is told of the identification code of the user device 12B from the user by telephone, and performs screen sharing to share the screen of the user device 12B by the operator terminal 10A and the user device 12B. The screen of the user device 12B is displayed on the operator terminal 10A. The operator is able to confirm and operate the screen of the user device 12B displayed on the operator terminal 10A.

Furthermore, in order to provide support, the operator may need to perform screen sharing with the user device 12A performing device cooperation with the user device 12B. The operator terminal 10A acquires an identification code of the user device 12A from the user device 12B, as described below. The operator terminal 10A performs screen sharing to share the screen of the user device 12A with the user device 12A, by using the acquired identification code of the user device 12A.

Similarly, the operator terminal 10B is also able to perform screen sharing with the user device 12A and the user device 12B, by using the acquired identification code of the user device 12A.

Furthermore, an operator A operating the operator terminal 10A can make a help support request to another operator B operating the operator terminal 10B, and cause the operator terminal 10B to also perform the screen sharing with the user device 12A and the user device 12B, with which the operator terminal 10A is performing screen sharing, and switch the screen sharing from the operator terminal 10A to the operator terminal 10B.

The operator is able to confirm and operate the screens of the user device 12A and the user device 12B by performing screen sharing with the user device 12A and the user device 12B, and therefore the operator can effectively provide the remote support. Furthermore, in the information processing system 1 according to the present embodiment, the operator terminal 10 is able to acquire the identification code of the user device 12A from the user device 12B with which screen sharing is already being performed, which is effective in that the user's load is low. Furthermore, the screen sharing can be switched between the operator terminal 10A and the operator terminal 10B, which is effective in that a plurality of operators are able to cooperate with each other and divide the operations.

<<Overview of Device Cooperation>>

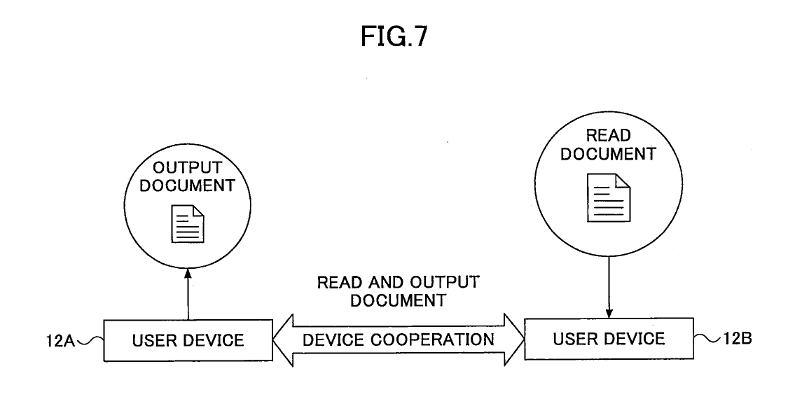

FIG. 7 is an image diagram of an example of device cooperation. FIG. 7 illustrates an example where image data is read from an original document and is output as a document, by device cooperation between the user device 12A and the user device 12B. For example, the user device 12A includes the printer 605. Furthermore, the user device 12B includes the scanner 606.

For example, when the user is using the user device 12A without the scanner 606 as an output device, device cooperation is made with the user device 12B having the scanner 606, such that an original document is read with the user device 12B and output (printed) from the user device 12A. By using such device cooperation, the user is able to realize copying of an original document, by using the user device 12A having a printing function and the user device 12B having a reading function.

Note that in the above, the user device 12A without the scanner 606 is described; however, the user device 12A with the scanner 606 may use the reading function of the user device 12B by device cooperation to realize the copying of an original document.

<<Operations of Remote Support>>

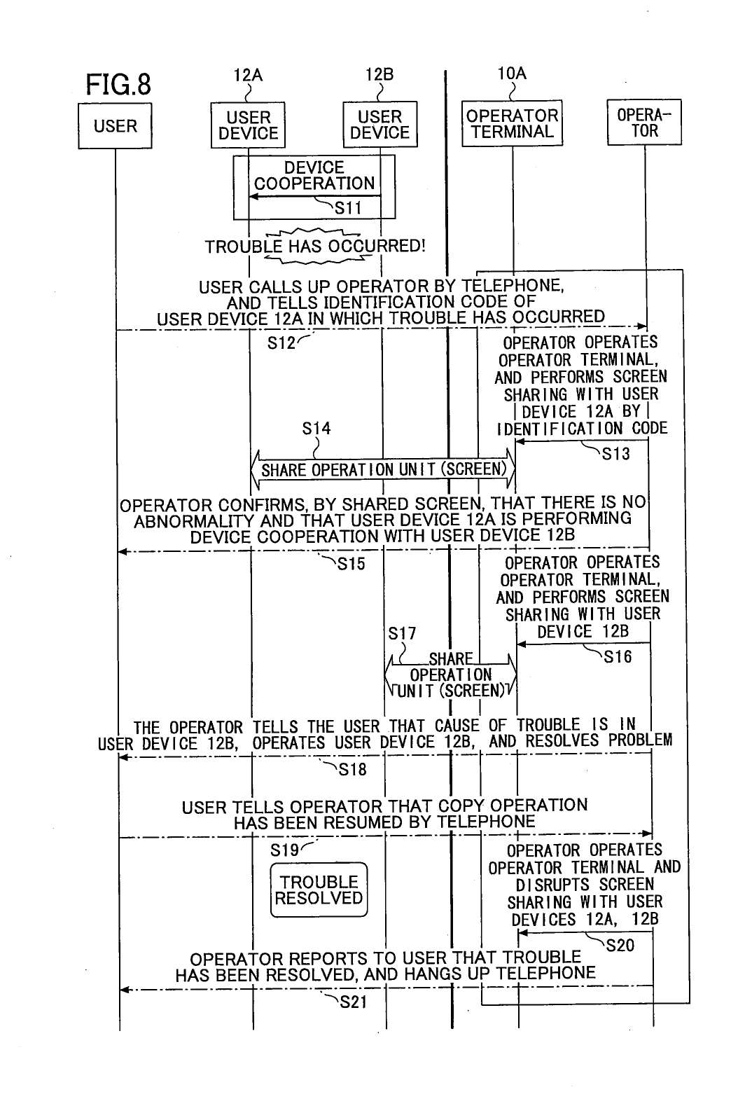

FIG. 8 is a sequence diagram of an example of operations of remote support according to the present embodiment. FIG. 8 illustrates an example of a copy operation in which the user reads an original document with the user device 12B and prints the image data from the user device 12A.

In step S11, the user operates the user device 12B, and instructs device cooperation in which the original document is read with the user device 12B and the image data is printed from the user device 12A. Note that the details of the process and screen transition of step S11 are described below. According to the instruction of step S11, the user device 12A performs printing when there is no trouble.

Here, the description is continued assuming that trouble has occurred, and the user device 12A has not performed printing. In step S12, the user calls up the operator by telephone, and tells the operator the identification code of the user device 12A in which printing is not being performed. Note that even at times other than when trouble occurs, for example, the user may call up the operator by telephone when the user does not know how to perform operations for device cooperation, and may tell the operator the identification code of the user device 12A.

In step S13, the operator instructs screen sharing with the user device 12A by inputting, in the operator terminal 10A, the identification code of the user device 12A told by the user. The identification code receiving unit 21 of the operator terminal 10A receives input of the identification code of the user device 12A.

In step S14, the first screen sharing unit 22 of the operator terminal 10A starts to share the screen (the operation unit) of the user device 12A, by using the identification code of the user device 12A received by the identification code receiving unit 21. The operator refers to the screen of the user device 12A displayed on the operator terminal 10A by screen sharing. Here, it is assumed that the operator has confirmed that there is no abnormality in the user device 12A and that the user device 12A is performing device cooperation with the user device 12B (step S15). Note that the operator may confirm that the user device 12A and the user device 12B are performing device cooperation by, for example, a telephone call with the user.

In step S16, the operator operates the operator terminal 10A, and instructs screen sharing with the user device 12B. In step S17, the second screen sharing unit 23 of the operator terminal 10A starts to share the screen (the operation unit) of the user device 12B, by using the identification code of the user device 12B acquired from the user device 12A, based on the request from the operator. The operator refers to the screen of the user device 12B that has been displayed on the operator terminal 10A according to screen sharing. Here, it is assumed that the operator has confirmed that there is an abnormality in the user device 12B.

In step S18, the operator tells the user that the cause of the trouble is in the user device 12B by using, for example, a telephone. Furthermore, the operator operates the user device 12B from the shared screen of the user device 12B displayed on the operator terminal 10A, and resolves the abnormality that has occurred in the user device 12B.

As the abnormality that has occurred in the user device 12B is resolved, the copy operation according to device cooperation by the user device 12A and the user device 12B is resumed. The user tells the operator that the copy operation according to device cooperation by the user device 12A and the user device 12B has been resumed by, for example, telephone (step S19).

As the trouble has been resolved, in step S20, the operator operates the operator terminal 10A and instructs to disrupt the screen sharing with the user device 12A and the user device 12B. The screen sharing disruption unit 25 of the operator terminal 10A disrupts (terminates) the screen sharing with the user device 12A and the user device 12B, according to the instruction from the operator.

Then, in step S21, after the operator reports to the user that the trouble has been resolved, the operator hangs up the telephone call with the user, and ends the remote support. Note that the process and the screen transition of the operator terminal 10A in the sequence diagram of FIG. 8 are described below in detail.

Note that the above describes an example in which the operator operates the user device 12B from the shared screen of the user device 12B displayed on the operator terminal 10A, and the abnormality that has occurred in the user device 12B is resolved. In another example, the operator may instruct the user to operate the user device 12B to resolve the abnormality, and cause the user to resolve the abnormality that has occurred in the user device 12B.

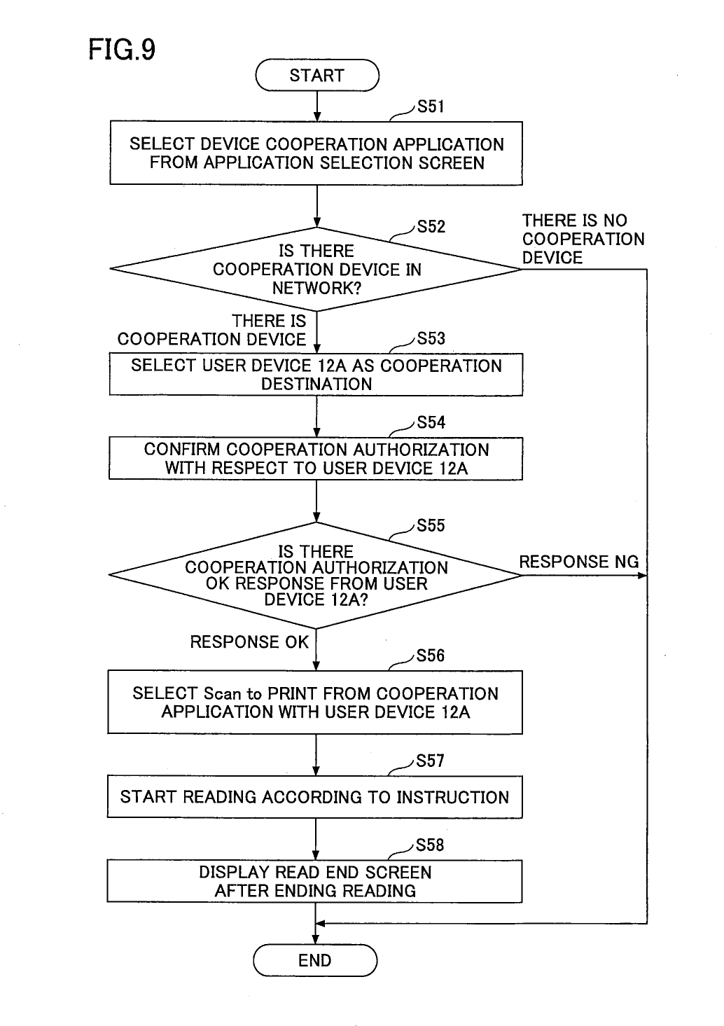

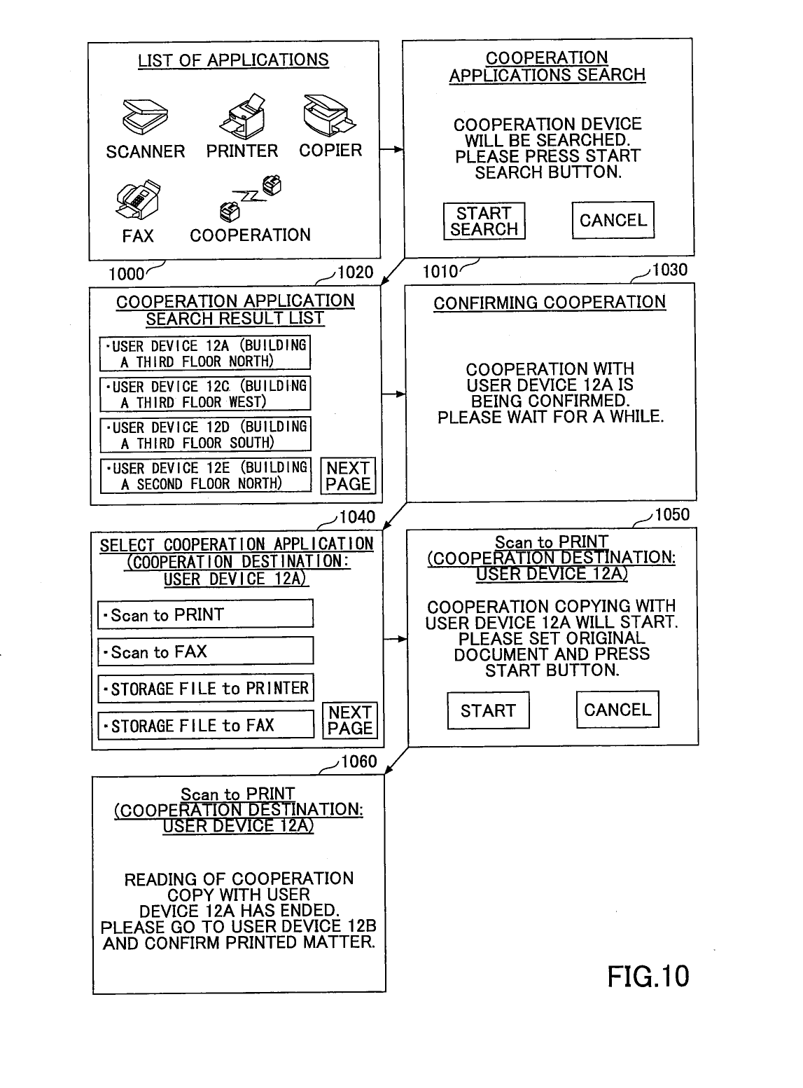

FIGS. 9 and 10 illustrate examples of the process and the screen transition of step S11. FIG. 9 is a flowchart of an example of a process performed by the user device that is the cooperation source. Furthermore, FIG. 10 illustrates an example of screen transition in the user device that is the cooperation source.

In the operation panel 602 of the user device 12B that is the cooperation source, for example, an application selection screen 1000 is displayed. In step S51, the user device 12B receives an operation of selecting a device cooperation application from the user.

In step S52, the cooperation device search unit 31 of the user device 12B displays a cooperation destination device search screen 1010 on the operation panel 602, and when the user presses a “start search” button, the screen transitions to a search in progress screen (not illustrated). The cooperation device search unit 31 searches for a cooperation device in the network N1.

When a cooperation device is found by the search, in step S53, the cooperation device search unit 31 displays a cooperation device list screen 1020 on the operation panel 602. Note that when a cooperation device is not found by the search, device cooperation cannot be performed, and therefore the user device 12B ends the process of the flowchart of FIG. 9.

Here, the description is continued assuming that the user has selected the user device 12A from the cooperation device list screen 1020. When the user device 12A is selected from the cooperation device list screen 1020, the cooperation authorization confirming unit 32 displays a cooperation authorization confirming screen 1030 on the operation panel 602, and confirms cooperation authorization with respect to the user device 12A that has been selected as the cooperation destination (step S54). Then, in step S55, the cooperation authorization confirming unit 32 waits for a cooperation authorization response from the user device 12A.

When a cooperation authorization response is received from the user device 12A, the cooperation function selecting unit 33 displays a cooperation application selection screen 1040 on the operation panel 602. Here, the description is continued assuming that the user has selected “scan to print” from the cooperation application selection screen 1040. In step S56, the cooperation function selecting unit 33 receives the selection of “scan to print” from the user.

In step S57, the cooperation function execution unit 34 displays an original document read instruction screen 1050 on the operation panel 602, according to the selection of “scan to print” from the user. When the “start” button in the original document read instruction screen 1050 is pressed, the cooperation function execution unit 34 starts to read the original document.

When the reading of the original document ends, in step S58, the cooperation function execution unit 34 displays a read end screen 1060 on the operation panel 602, and reports to the user that the reading of the original document has ended and that printed matter will be output by the user device 12A. Furthermore, the cooperation function execution unit 34 sends the image data read from the original document, to the user device 12A.

Note that when a cooperation authorization response from the user device 12A is not received for a certain time period or when a cooperation refusal response is received in step S55, the user device 12B ends the process of the flowchart of FIG. 9.

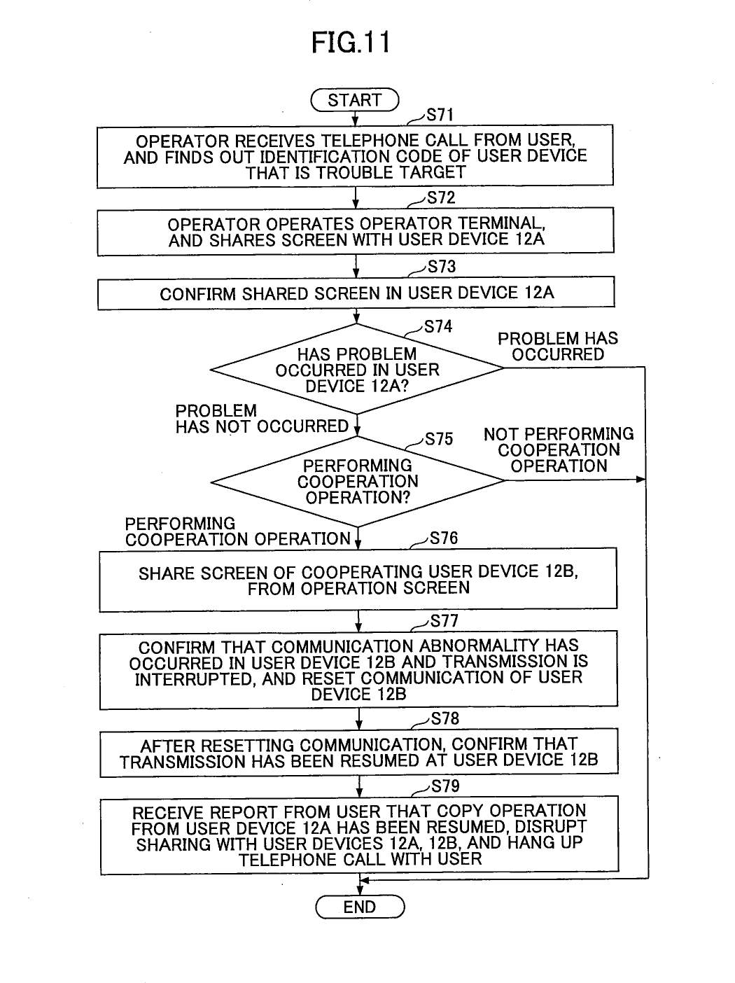

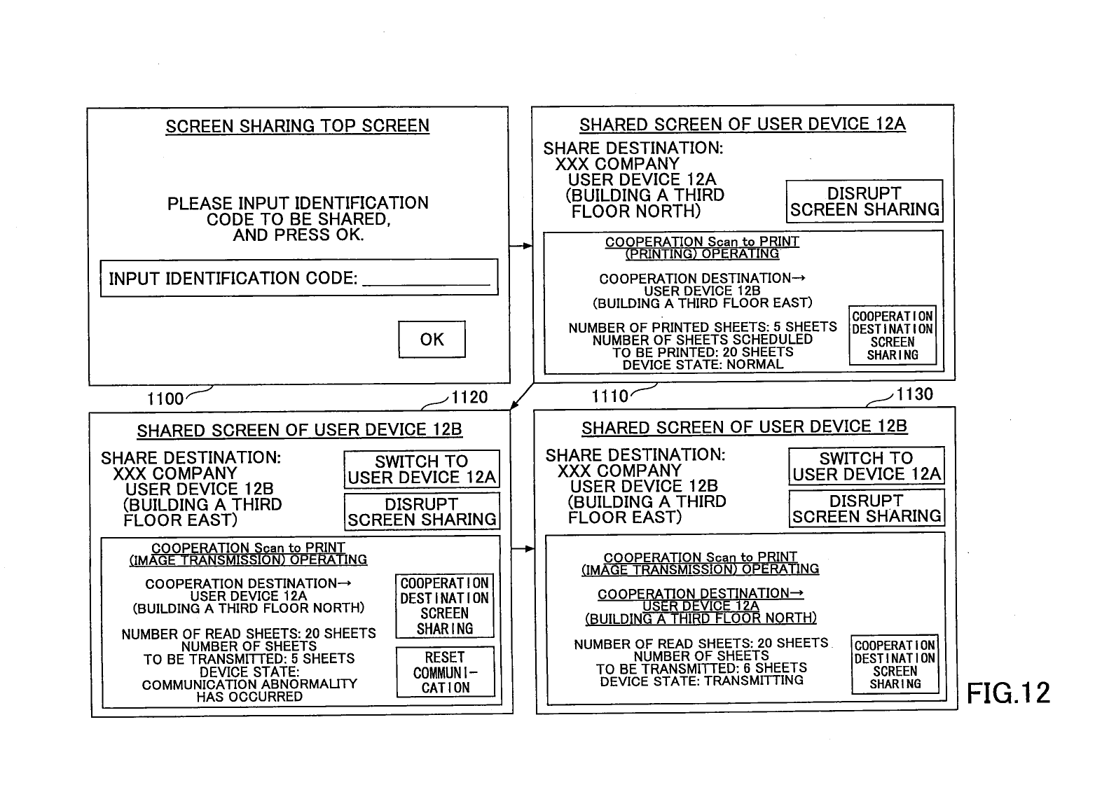

FIGS. 11 and 12 illustrate examples of the process and the screen transition of the operator terminal 10A in the sequence diagram of FIG. 8. FIG. 11 is a flowchart of an example of a process performed by the operator terminal. Furthermore, FIG. 12 illustrates an example of screen transition in the operator terminal.

In step S71, the operator receives a telephone call from the user, informing that trouble has occurred in the user device 12A. The operator is told of the identification code of the user device 12A that is the trouble target, from the user.

In step S72, the operator instructs screen sharing with the user device 12A, by inputting the identification code of the user device 12A told by the user in an identification code input screen 1100 of the operator terminal 10A. The identification code receiving unit 21 of the operator terminal 10A receives input of the identification code of the user device 12A.

The first screen sharing unit 22 of the operator terminal 10A starts sharing the screen (the operation unit) of the user device 12A, and displays a shared screen 1110 of user device 12A on the display device 502, by using the identification code of the user device 12A.

In step S73, the operator refers to the displayed shared screen 1110 of the user device 12A, and confirms whether an abnormality (problem) has occurred in the user device 12A (step S74), and whether the user device 12A is performing device cooperation with another user device 12 (step S75). In the example of the shared screen 1110 of the user device 12A in FIG. 12, the operator confirms that there is no abnormality in the user device 12A and that the user device 12A is performing device cooperation with the user device 12B.

In steps S74 and S75, when the operator confirms that there is no abnormality in the user device 12A and that the user device 12A is performing device cooperation with the user device 12B, the process proceeds to step S76, and the operator presses the “cooperation destination screen sharing” button in the shared screen 1110 of the user device 12A.

When the “cooperation destination screen sharing” button in the shared screen 1110 of the user device 12A is pressed, the second screen sharing unit 23 starts screen sharing with the user device 12B based on the request from the operator, and displays a shared screen 1120 of the user device 12B on the display device 502.

In step S77, the operator refers to the displayed shared screen 1120 of the user device 12B, and confirms whether an abnormality (problem) has occurred in the user device 12B. For example, in the example of the shared screen 1120 of the user device 12B, the operator confirms that a communication abnormality has occurred in the user device 12B and that the transmission of the read image is interrupted.

Accordingly, the operator presses the “reset communication” button in the shared screen 1120 of the user device 12B, and instructs to reset communication. The remote operation unit 26 of the operator terminal 10A resets the communication of the user device 12B.

When the communication abnormality in the user device 12B is resolved after resetting the communication, the shared screen 1120 of the user device 12B changes to a shared screen 1130, in which the device state changes to transmitting. Therefore, in step S78, the operator is able to confirm that the transmission of the read image is resumed in the user device 12B.

In step S79, when the operator is told by the user that the copy operation according to device cooperation by the user device 12A and the user device 12B has been resumed, the operator presses the “disrupt screen sharing” button in the shared screen 1130 of the user device 12B. The screen sharing disruption unit 25 of the operator terminal 10A disrupts the screen sharing by the user device 12A and the user device 12B, according to the instruction from the operator. Then, the operator reports to the user that the trouble has been resolved, hangs up the telephone call with the user, and ends the remote support.

Note that in the shared screen 1120 and the shared screen 1130 of FIG. 12, a “switch to user device 12A” button is displayed, and the shared screen 1120 or the shared screen 1130 receives an instruction from the operator to switch to the shared screen 1110 of the user device 12A. When the “switch to user device 12A” button of the shared screen 1120 or the shared screen 1130 is pressed, the shared screen switching unit 24 switches to the shared screen 1110 of the user device 12A from the shared screen 1120 or the shared screen 1130.

Furthermore, in the example of FIG. 12, the shared screen 1110 of user device 12A and the shared screen 1120 or the shared screen 1130 of the user device 12B are switched and displayed; however, both may be displayed at the same time.

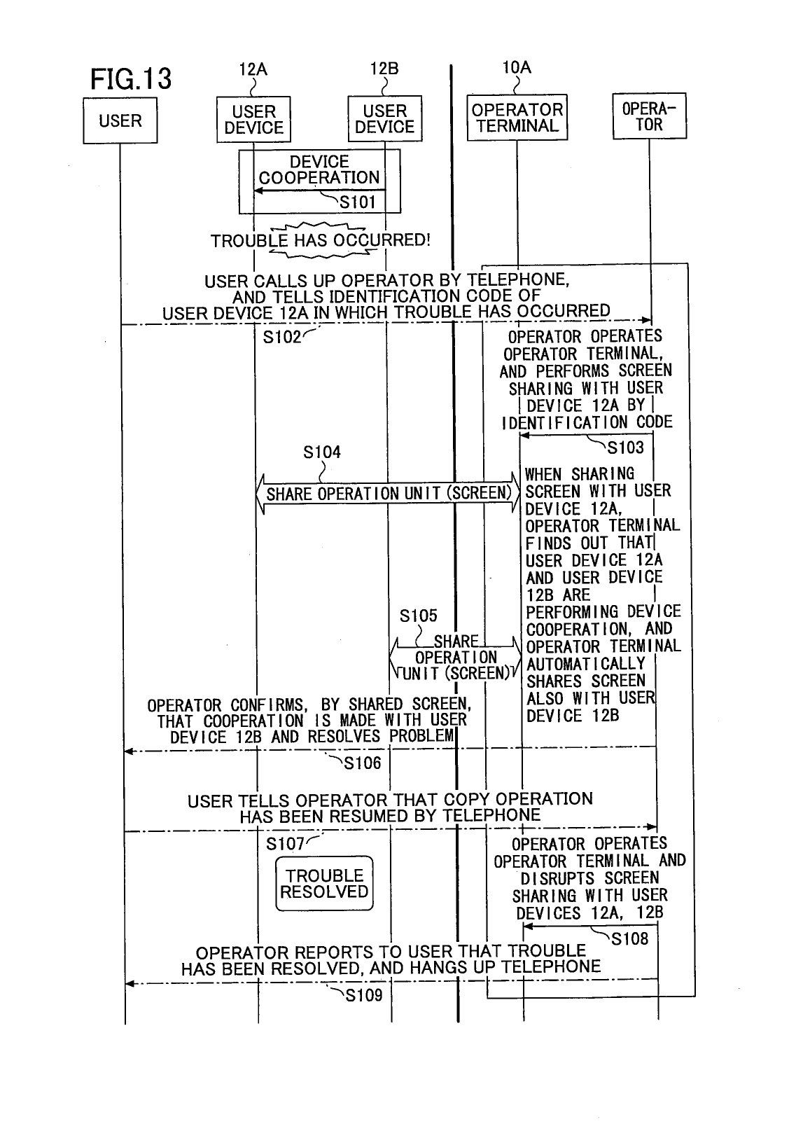

FIG. 13 is a sequence diagram of another example of the operations of remote support according to the present embodiment. The sequence diagram of FIG. 13 is the same as the sequence diagram of FIG. 8 except for some portions, and therefore descriptions are omitted according to need.

The processes of steps S101 through S103 are the same as the processes of steps S11 through S13 of FIG. 8, and therefore descriptions thereof are omitted.

In step S104, the first screen sharing unit 22 of the operator terminal 10A starts sharing the screen (the operation unit) of the user device 12A, by using the identification code of the user device 12A received by the identification code receiving unit 21. Furthermore, as a result of the screen sharing with the user device 12A in step S104, when the second screen sharing unit 23 of the operator terminal 10A determines that the user device 12A is performing device cooperation with the user device 12B, in step S105, the second screen sharing unit 23 automatically starts to share the screen (the operation unit) of the user device 12B. Note that the second screen sharing unit 23 can start sharing the screen of the user device 12B, by acquiring the identification code of the user device 12B from the user device 12A.

In step S106, the operator operates the user device 12B from the shared screen of the user device 12B displayed on the operator terminal 10A, and resolves the abnormality that has occurred in the user device 12B. The processes of steps S107 and onward are the same as the processes of steps S19 and onward of FIG. 8, and therefore descriptions thereof are omitted.

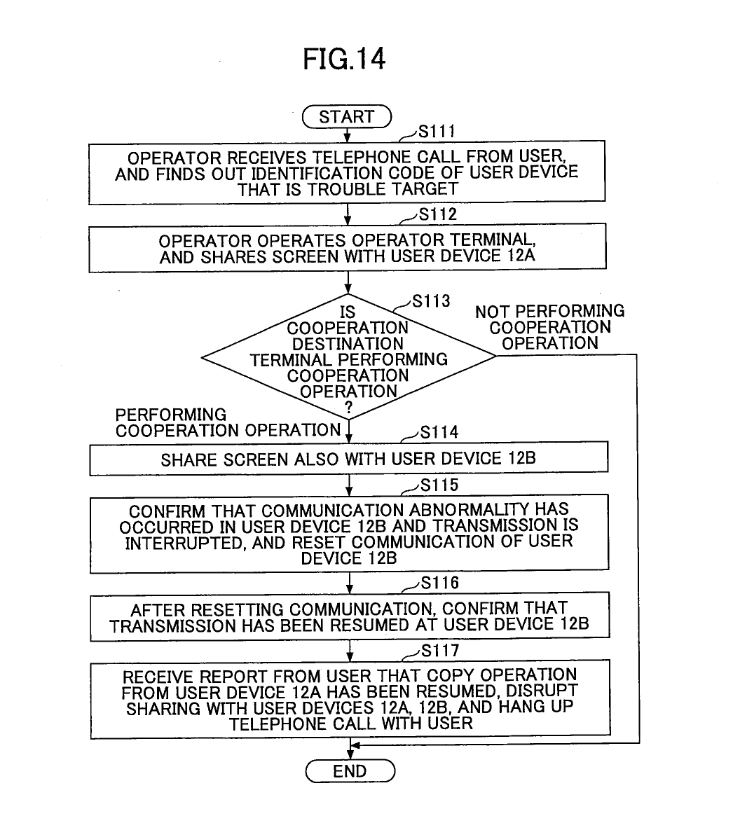

The process by the operator terminal 10A in the sequence diagram of FIG. 13 is performed as illustrated in the flowchart of FIG. 14, for example. FIG. 14 is a flowchart of another example of a process performed by the operator terminal. Note that the flowchart of FIG. 14 is the same as the flowchart of FIG. 11 except for some portions, and therefore descriptions are omitted according to need. The processes of steps S111 and S112 are the same as the processes of steps S71 and S72 of FIG. 11, and therefore descriptions thereof are omitted.

In step S113, the second screen sharing unit 23 of the operator terminal 10A determines whether the user device 12A is performing device cooperation with the user device 12B. When a cooperation operation is being performed, in step S114, the second screen sharing unit 23 starts sharing the screen of the user device 12B, and displays the shared screen 1120 of the user device 12B on the display device 502. The processes of steps S115 and onward are the same as the processes of steps S77 and onward of FIG. 11, and therefore descriptions thereof are omitted. Furthermore, when a cooperation operation is not being performed in step S113, the operator terminal 10A ends the process of the flowchart of in FIG. 14.

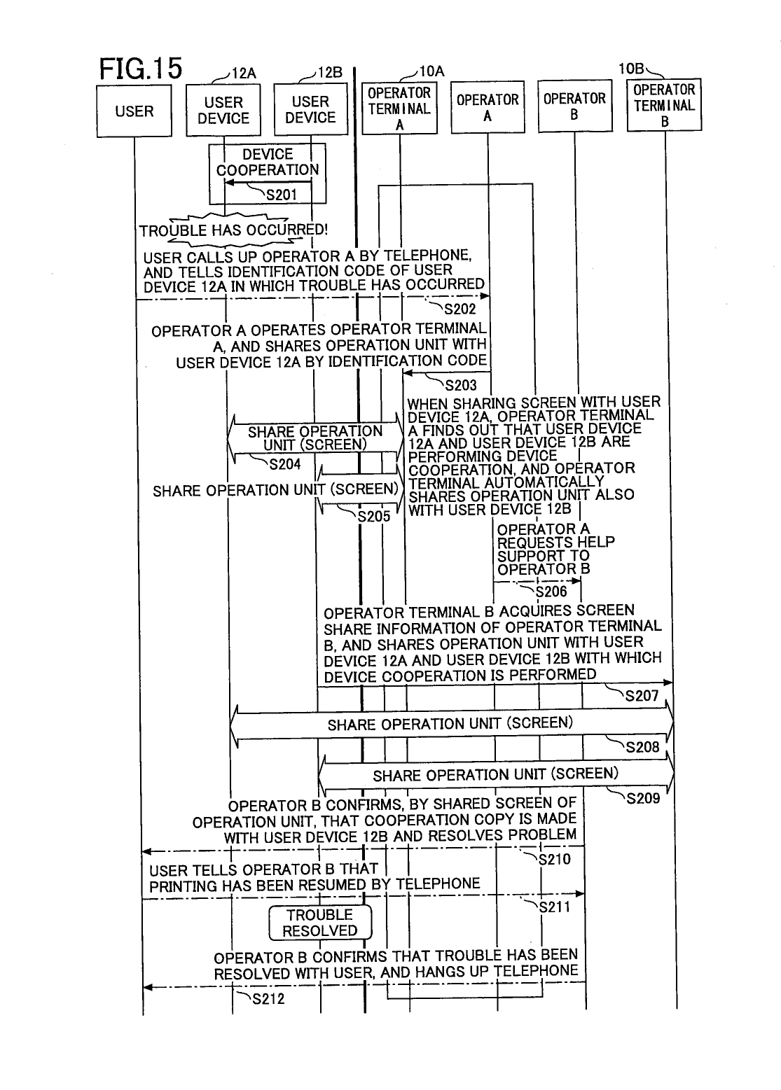

FIG. 15 is a sequence diagram of yet another example of the operations of remote support according to the present embodiment. The sequence diagram of FIG. 15 is the same as the sequence diagram of FIG. 13 except for some portions, and therefore descriptions are omitted according to need.

The processes of steps S201 through S205 are the same as the processes of steps S101 through S105 of FIG. 13, and therefore descriptions thereof are omitted.

In step S206, the operator A operating the operator terminal 10A makes a request for help support to the operator B operating the operator terminal 10B. The operator B is told of the identification code of the user device 12A with which screen sharing is presently being performed with the operator terminal 10A, from the operator A, and starts to share the screen (the operation unit) of the user device 12A and the screen (the operation unit) of the user device 12B, by the same procedures as those of the operator terminal 10A (steps S208, S209).

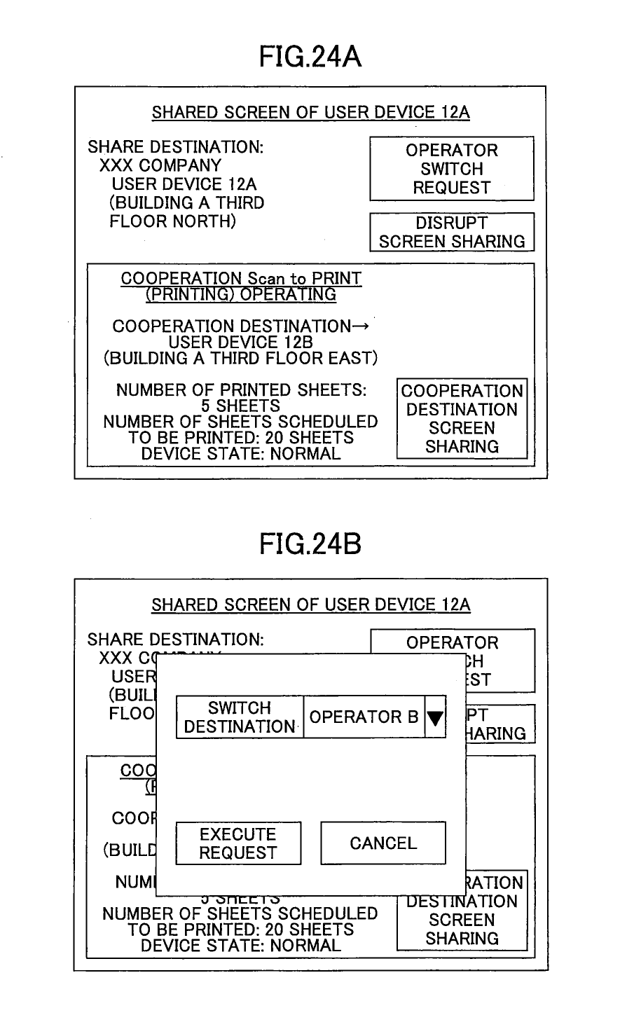

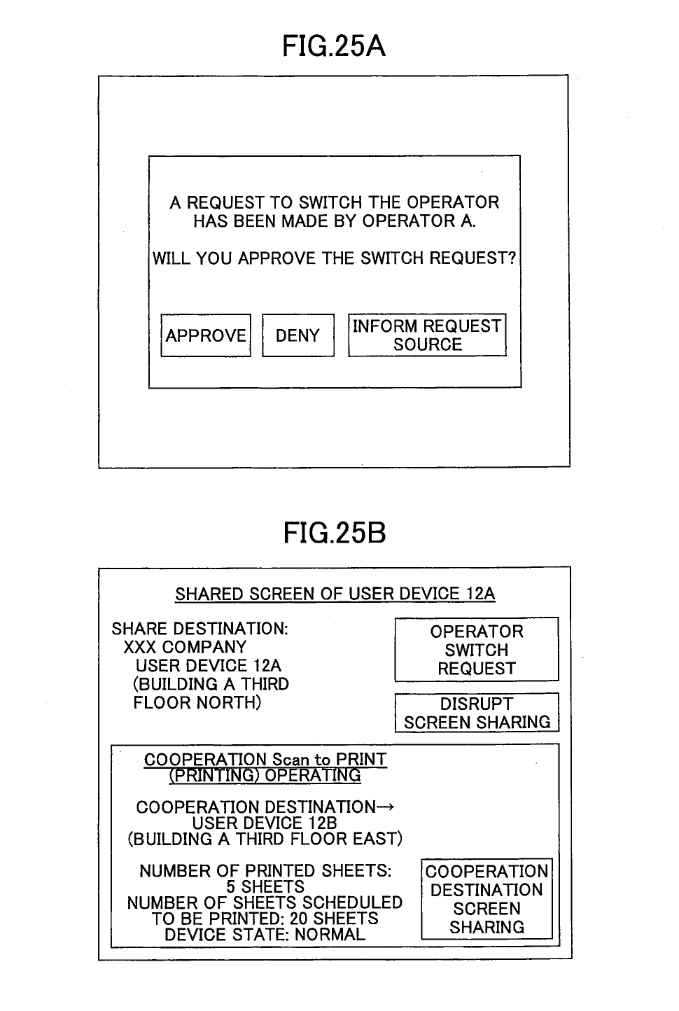

Note that as another embodiment, a request may be made via the operator terminal 10. For example, the operator terminal 10A displays a screen as illustrated in FIG. 24A. Then, when an input is made to “request another operator to respond” (for example, an “operator switch request” button is pressed), the operator terminal 10A displays an execution screen for selecting the operator that is the switch destination and for requesting the switch, as illustrated in FIG. 24B. Then, when an “execute request” button is pressed, the operator terminal 10A sends, to the operator terminal 10B that is the input request destination, a response request including the identification code of the user device 12A with which the operator terminal 10A is performing screen sharing. In response to the response request received from the operator terminal 10A, the operator terminal 10B displays a screen as illustrated in FIG. 25A for selecting whether to approve the request from the operator terminal 10A. When the operator terminal 10B receives an input of approval with respect to the displayed screen (for example, pressing an “approval” button”), the operator terminal 10B displays a screen as illustrated in FIG. 25B for sharing the operation unit with the user device 12A and the user device 12B, by using the identification code of the user device 12A received from the operator terminal 10A.

Here, when an “inform request source” button as illustrated in FIG. 25A is pressed, the operator terminal 10B may communicate with the operator terminal 10A that has made the switch request, such that the operator A and the operator B can call each other by telephone or chat with each other.

In step S210, the operator B operates the user device 12B from the shared screen of the user device 12B displayed on the operator terminal 10B, and resolves the abnormality that has occurred in the user device 12B. The processes of steps S210 and onward are the same as the processes of steps S19 and onward of FIG. 8, and therefore descriptions thereof are omitted.

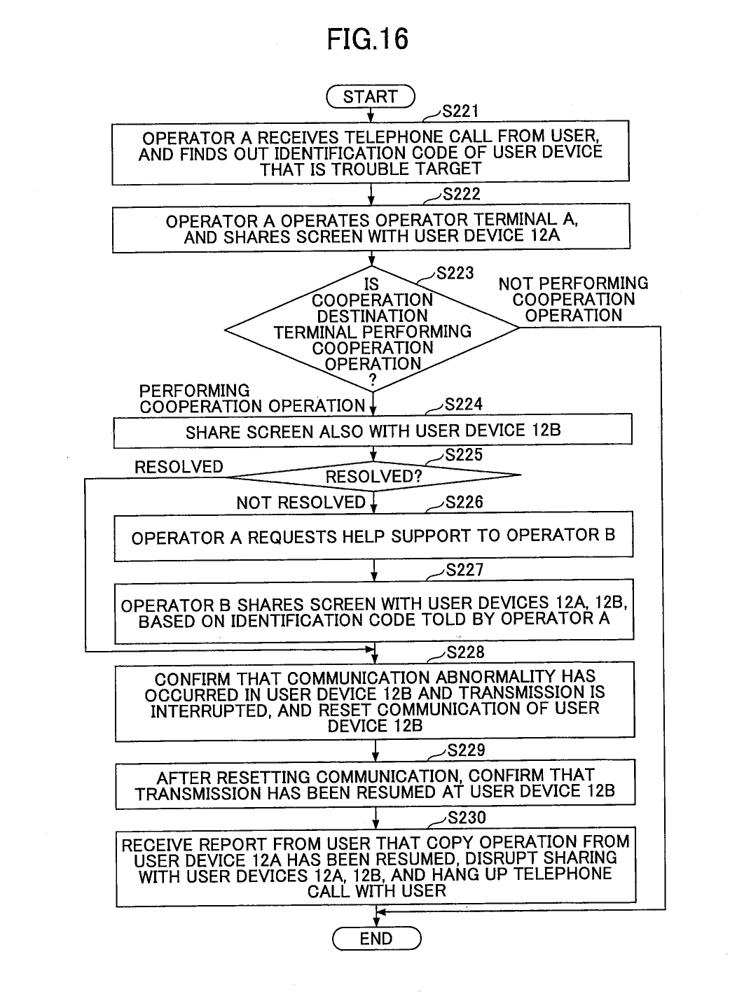

The process by the operator terminal 10A and the operator terminal 10B in the sequence diagram of FIG. 15 is performed as illustrated in the flowchart of FIG. 16, for example. FIG. 16 is a flowchart of yet another example of a process performed by the operator terminal. Note that the flowchart of FIG. 16 is the same as the flowchart of FIG. 14 except for some portions, and therefore descriptions are omitted according to need. The processes of steps S221 through S224 are the same as the processes of steps S111 through S114 of FIG. 14, and therefore descriptions thereof are omitted. Furthermore, the processes of steps S228 through S230 are the same as the processes of steps S115 through S117 of FIG. 14, and therefore descriptions thereof are omitted.

Up to step S224, after the operator terminal 10A performs screen sharing with the user devices 12A and 12B, and the operator A of the operator terminal 10A is unable to resolve the cause of the trouble, the operator A requests the operator B to provide help support (step S225).

The operator B that has received the request from the operator A, receives, from the operator A, the identification code for connecting to the user devices 12A and 12B with which the operator terminal 10A is performing screen sharing, and the operator terminal 10B performs screen sharing with the user devices 12A and 12B, similar to the operator terminal 10A. At this time, the screen sharing between the operator terminal 10A and the user devices 12A and 12B may be disrupted (step S226).

Subsequently, the operator B confirms the cause of the trouble and resolves the trouble, similar to the operator of FIG. 14 (steps S228 through S230).

### Other Embodiment

In the first embodiment, the user interacts with the operator by telephone; however, in another embodiment, the user interacts with the operator by using the user device 12. Note that descriptions that overlap those of the first embodiment are omitted.

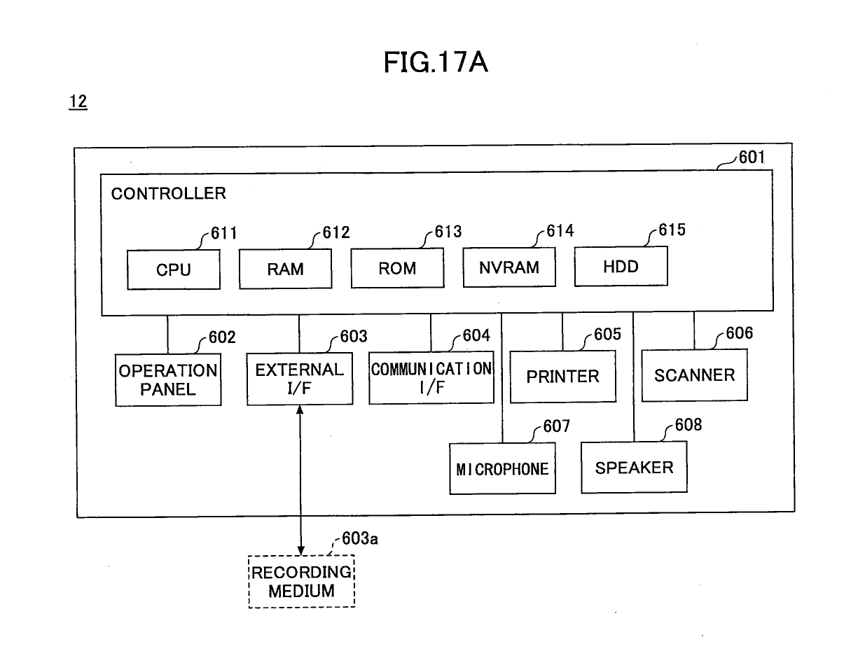

FIGS. 17A and 17B illustrate a hardware configuration of an example of a user device and an operator terminal according to the present embodiment. Here, the user device 12 includes a microphone 607 and a speaker 608, in addition to the elements of the first embodiment. The computer 500 constituting the operator terminal 10 includes a microphone 509 and a speaker 510, in addition to the elements of the first embodiment.

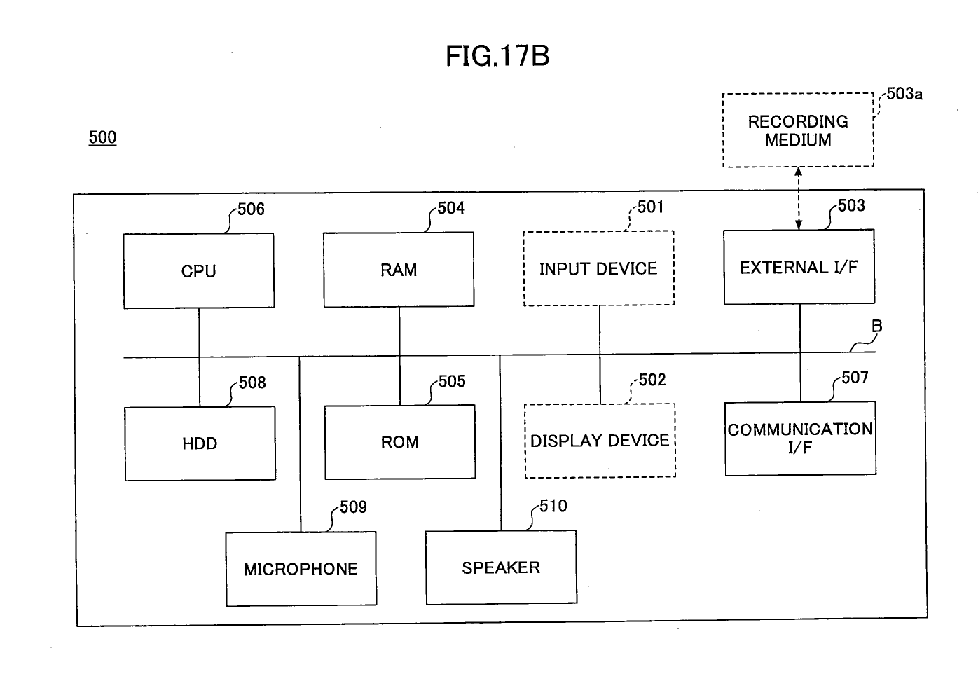

Next, with reference to FIG. 18, a description is given of a functional configuration of the user device 12 according to the present embodiment. FIG. 18 illustrates a process block diagram of the user device 12 according to the present embodiment. The user device 12 of FIG. 18 includes a storage unit 36, an input receiving unit 37, a display control unit 38, a share control unit 39, and a voice sound device control unit 40, in addition to the elements of the first embodiment.

The RAM 612, the ROM 613, the NVRAM 614, the HDD 615, etc., store various kinds of information as the storage unit 36. For example, when executing a cooperation process by the cooperation function execution unit 34, the storage unit 36 stores various kinds of setting information of the cooperation process (device information of the cooperation destination, device information of the cooperation source, settings of the cooperation process, etc.).

The input receiving unit 37 receives information that is input from the user via the operation panel 602. The display control unit 38 displays information on the operation panel 602. Note that when the user device 12 is, for example, a projector, the display control unit 38 displays the information by causing a projecting device (corresponding to the above display unit) to project the information. The voice sound device control unit 40 controls the microphone 607 and the speaker 608 of the user device 12.

The share control unit 39 sends a share request to request the execution of sharing the display contents, to the operator terminal 10 via the communication I/F 604. Furthermore, the share control unit 39 receives, via the communication I/F 604, a share start request to request the start of sharing the display contents, from the operator terminal 10.

In the sharing process, the share control unit 39 transmits and receives information relevant to sharing the display contents, with the operator terminal 10 via the communication I/F 604. For example, the share control unit 39 receives information (for example, the movement of the cursor, the selection of an icon, voice sound input from the microphone 509, etc.) input at the operator terminal 10. Furthermore, the share control unit 39 sends information (for example, a touch operation, the selection of a button, voice sound input from the microphone 607, etc.) input at the user device 12.

Furthermore, the first screen sharing unit 22 and the second screen sharing unit 23 according to the present embodiment do not only share screens, but also perform voice sound communication by using the microphone 607 and the speaker 608 of the user device 12, and the microphone 509 and the speaker 510 of the operator terminal 10.

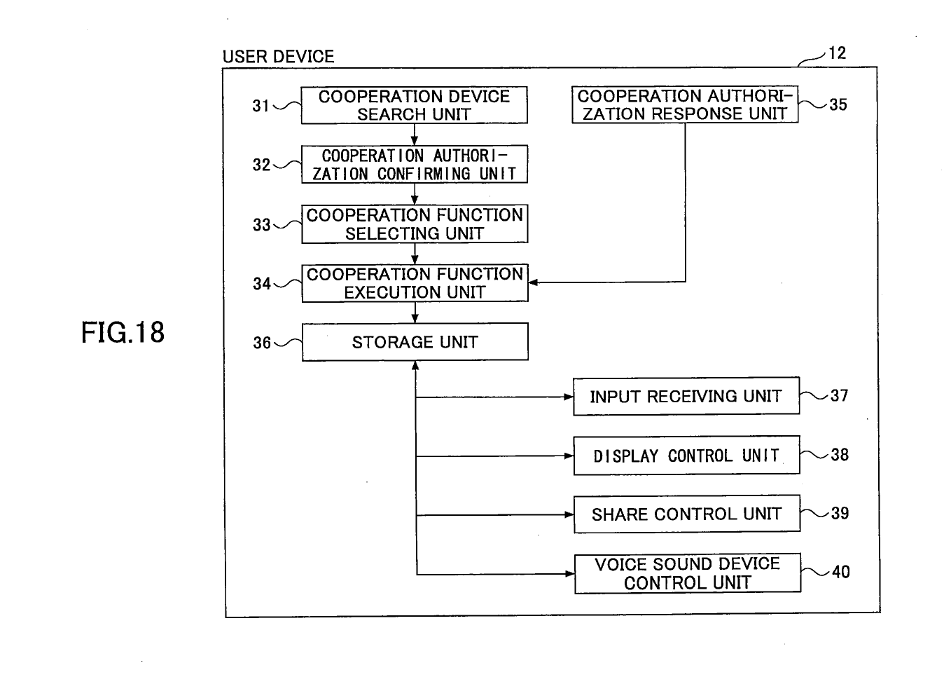

Next, a detailed description is given of a process according to the present embodiment, based on a sequence diagram of the present embodiment illustrated in FIG. 19. Note that in the present embodiment, it is assumed that device cooperation is performed by reading an original document with the user device 12B, and executing printing with the user device 12A.

The input receiving unit 37 of the user device 12B receives input of a device cooperation instruction (step S121). The device cooperation instruction is executed by the method described with reference to FIGS. 9 and 10. The user device 12B and the user device 12A execute a device cooperation process (step S122).

Here, as described with reference to FIGS. 8 and 13, it is assumed that reading has been completed at the user device 12B, but trouble has occurred in that data transmission is not performed from the user device 12B to the user device 12A due to a communication abnormality, and the printed matter is not output from the user device 12A.

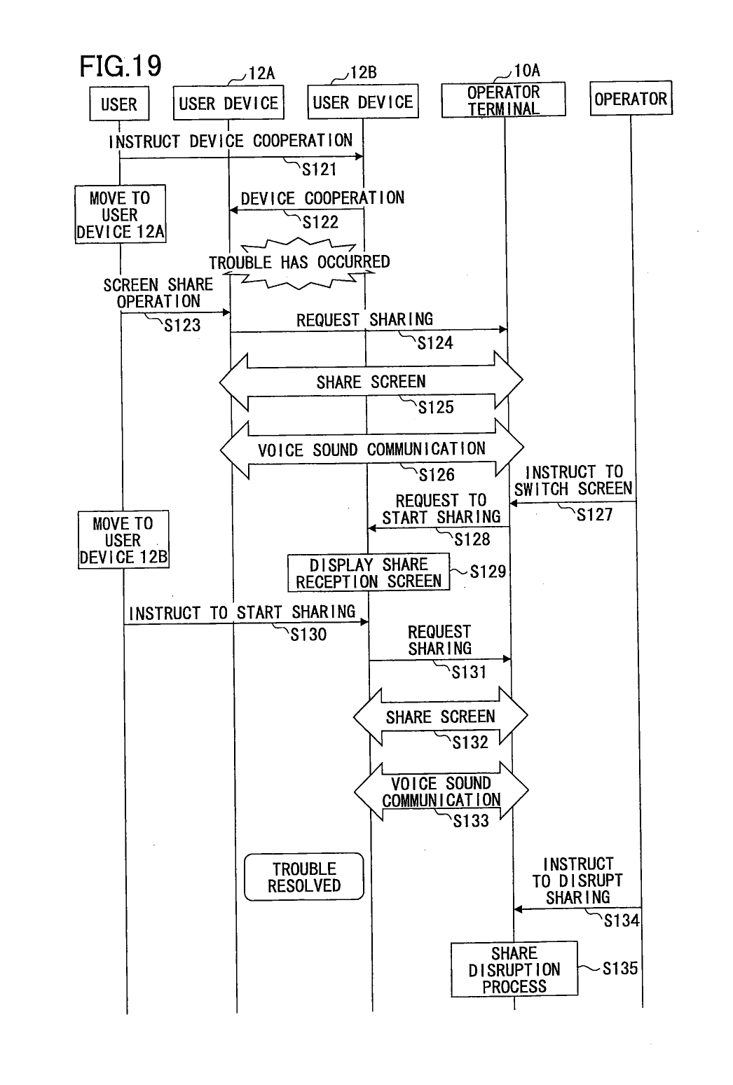

The user, who has moved to the user device 12A, confirms that printed matter is not output from the user device 12A. The input receiving unit 37 of the user device 12A receives input of an operation for executing screen sharing (step S123). Specifically, a screen 1200 illustrated in FIG. 20 is displayed on the user device 12A, and the user performs an operation of executing screen sharing, by selecting the “remote assist” icon.

Referring back to FIG. 19, when the input receiving unit 37 of the user device 12A receives the operation to execute screen sharing, the share control unit 39 of the user device 12A sends a share request, requesting the execution of a sharing process, to the operator terminal 10A (step S124). This share request includes the identification code of the user device 12A and state information of the user device 12A (consumable information, error information, execution job history, information of the cooperation process, etc.).

The first screen sharing unit 22 of the operator terminal 10A performs sharing (screen sharing) of the display contents with the user device 12A, based on the identification code included in the received share request (step S125). When screen sharing is performed, a screen such as the shared screen 1110 of FIG. 12 is displayed on the screen of the operator terminal 10A. Furthermore, the first screen sharing unit 22 of the operator terminal 10A starts voice sound communication with the user device 12A, based on the share request (step S126).

By starting the voice sound communication, the user and the operator are able to talk to each other via the user device 12A and the operator terminal 10A. Note that the voice sound communication may be performed via the same network as that used for screen sharing, or by using a different network from that used for screen sharing, such as a telephone line.

The shared screen switching unit 24 of the operator terminal 10A receives a screen switch instruction from the operator (step S127). Then, the shared screen switching unit 24 identifies the user device 12B based on information of the cooperation process included in the share request received by the second screen sharing unit 23 of the operator terminal 10A, and sends, to the user device 12B, a share start request, requesting to start the sharing process (step S128).

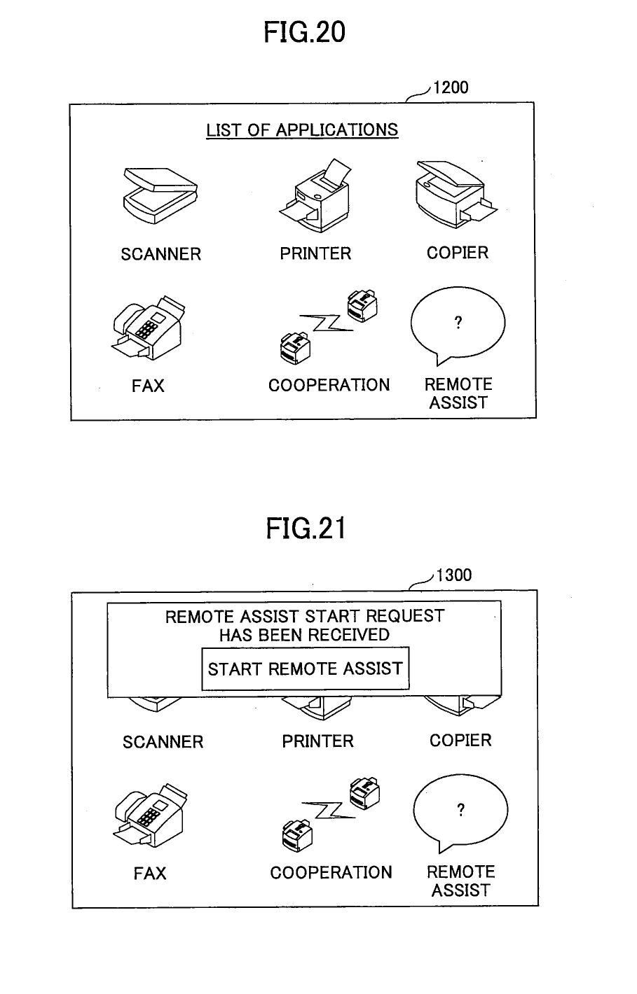

When the share control unit 39 of the user device 12B receives a share start request, the display control unit 38 of the user device 12B displays a share reception screen 1300 as illustrated in FIG. 21, indicating that the share start request has been received (step S129). As the user moves to the user device 12B, and selects the “start remote assist” button displayed as illustrated in FIG. 21, the input receiving unit 37 of the user device 12B receives input of a share start instruction (step S130).

When the input receiving unit 37 of the user device 12B receives the input of the share start instruction, the share control unit 39 of the user device 12B sends a share request to the operator terminal 10A (step S131). When the second screen sharing unit 23 of the operator terminal 10A receives a share request, the second screen sharing unit 23 of the operator terminal 10A performs screen sharing with the user device 12B, by the same processes as those of steps S125 and S126 (step S132). Furthermore, the second screen sharing unit 23 of the operator terminal 10A starts voice sound communication with the user device 12B (step S133). When the screen sharing and the voice sound communication are started, the operator terminal 10A performs steps S77 and S78 of FIG. 11.

When the trouble is resolved (data transmission is normally performed from the user device 12B, and the printed matter is output from the user device 12A), the screen sharing disruption unit 25 of the operator terminal 10A receives input of a share disrupt instruction from the operator (step S134). Then, the screen sharing disruption unit 25 of the operator terminal 10A disrupts the screen sharing and the voice sound communication with the user device 12B and the user device 12A (step S135).

Note that the disruption of the screen sharing and the voice sound communication with the user device 12A may be executed when a screen switch instruction is input. Furthermore, when a screen switch instruction is input, only the voice sound communication may be disrupted, and the screen sharing may be continued.

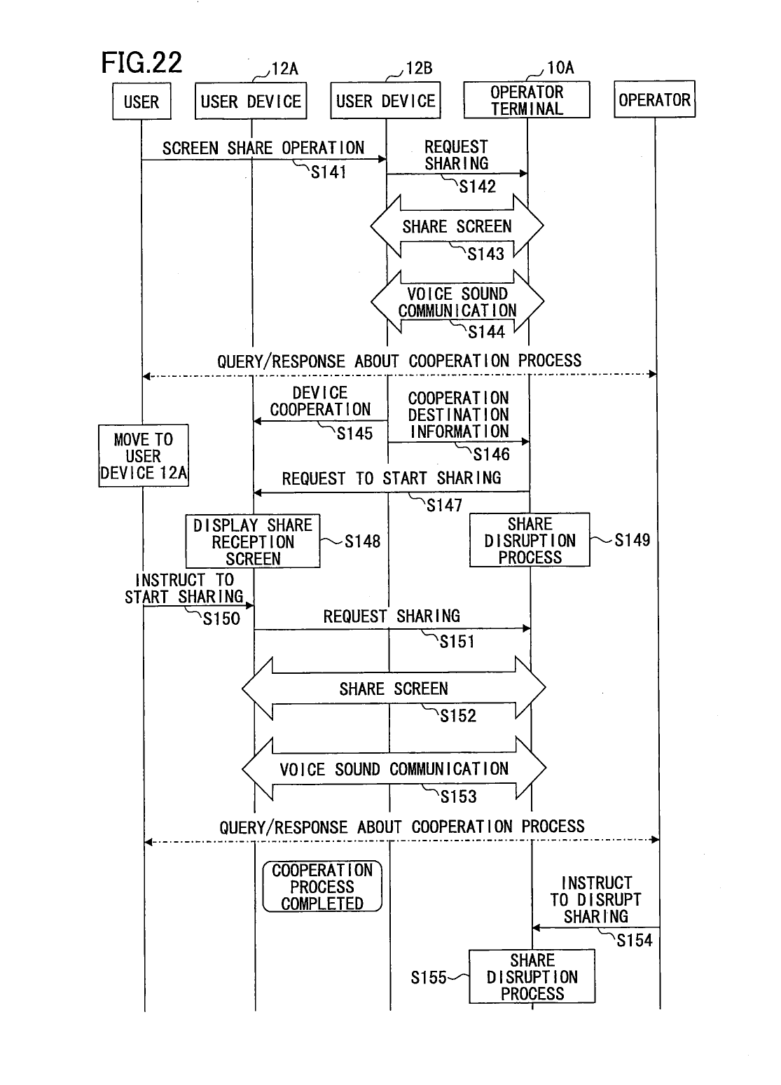

Next, a description is given of a support process in a case where the user does not know the operation method of the cooperation operation, with reference to a sequence diagram of FIG. 22.

As the user selects the “remote assist” icon in the screen 1200 of FIG. 20 displayed on the user device 12B, the input receiving unit 37 of the user device 12B receives input of an operation for executing screen sharing (step S141). When the input receiving unit 37 of the user device 12B receives input of the operation for executing screen sharing, the share control unit 39 of the user device 12B sends a share request, requesting the execution of a sharing process, to the operator terminal 10A (step S142). This share request includes the identification code of the user device 12A and state information of the user device 12A (consumable information, error information, execution job history, information of the cooperation process, etc.).

The second screen sharing unit 23 of the operator terminal 10A performs sharing (screen sharing) of the display contents with the user device 12B, based on the identification code included in the received share request (step S143). When screen sharing is executed by the second screen sharing unit 23 of the operator terminal 10A, a screen such as the shared screen 1110 of FIG. 12 is displayed on the screen of the operator terminal 10A. Furthermore, the operator terminal 10A and the user device 12A start voice sound communication based on the share request (step S144).

When the screen sharing and the voice sound communication are performed, the user and the operator perform an operation of executing the cooperation process by querying and responding about the cooperation process (for example, the operation described with reference to FIG. 10). The user device 12B and the user device 12A execute a device cooperation process according to the input by the user or the operator (step S145). When the device cooperation process is executed, the share control unit 39 of the user device 12B sends, to the operator terminal 10A, the information (identification code, etc.) of the user device 12A that is the cooperation destination (step S146).

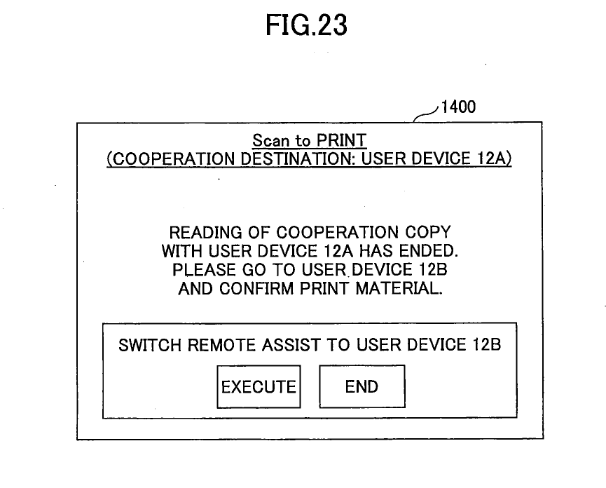

Note that the information of the user device 12A may be sent at various timings. For example, the user device 12B may send the information of the user device 12A when the cooperation process operation executed at the user device 12B has ended (for example, when the original document reading operation has ended). Furthermore, the user device 12B may send the information of the user device 12A when the cooperation process executed at the user device 12B has started (for example, when the original document reading operation has started). Furthermore, as illustrated in FIG. 23, the user may be prompted to input an instruction of switching the remote assist.

The first screen sharing unit 22 of the operator terminal 10A sends a share start request to the user device 12A, based on the received cooperation destination information (step S147). When the share control unit 39 of the user device 12A receives the share start request, the display control unit 38 of the user device 12A causes the operation panel 602 to display the share reception screen 1300 as illustrated in FIG. 21 (step S148). Furthermore, when the share start request is sent to the user device 12A, the screen sharing disruption unit 25 of the operator terminal 10A disrupts the sharing with the user device 12B (step S149).

The user selects the “start remote assist” button of FIG. 21, and inputs a share start instruction (step S150). When the user device 12A receives input of the share start instruction, the user device 12A sends a share request to the operator terminal 10A (step S151). When the operator terminal 10A receives the share request, the operator terminal 10A performs screen sharing with the user device 12A, by the same processes as those of steps S143 and S144 (step S152), and starts voice sound communication with the user device 12A (step S153).

When the screen sharing and the voice sound communication are performed, the user and the operator perform an operation of executing the cooperation process by querying and responding about the cooperation process. When the cooperation process is completed, the operator terminal 10A receives input of a share disrupt instruction from the operator (step S154), performs a share disruption process, and ends the screen sharing and the voice sound communication with the user device 12A.

Note that in any of the above embodiments, the user device 12 does not have to be a multifunction peripheral. For example, the user device 12B may be a smart device, and the user device 12A may be a projector. In this case, the first screen sharing unit 22 may perform the sharing of the screen of the smart device and the screen of the operator terminal 10, and the second screen sharing unit 23 may perform the sharing of the screen projected by the projector and the screen of the operator terminal 10.

Here, it is possible to consider a process of, for example, causing the projector to project data (image data, video data, etc.) displayed by a smart device, as a cooperation operation by the smart device and the projector. As a matter of course, similarly, a cooperation operation by a smart device and an MFP (the data displayed by the smart device is printed by the MFP or fax-transmitted by the MFP) may also be considered.

Furthermore, in any of the above embodiments, the first screen sharing unit 22 and the second screen sharing unit 23 of the user device 12 may be integrated as a single screen sharing unit.

### OVERVIEW

According to the information processing system 1 according to the present embodiment, when remote support is continuously performed for a plurality of user devices 12 performing device cooperation, it is possible to reduce the procedures on the user's side for receiving the remote support, from the second user device and onward. Furthermore, a plurality of operators are able to cooperate with each other and divide the operations among each other, when providing the remote support.

These effects can be attained because in the information processing system 1 according to the present embodiment, the information, which is to be used by the operator terminal 10 to perform screen sharing with the second user device 12 and onward, can be acquired from the user device 12 with which screen sharing has already been performed. As described above, in the information processing system 1 according to the present embodiment, the user's load can be reduced, in the case of sharing the screen of the user device 12 between a plurality of user devices 12 performing device cooperation and the operator terminal 10. Furthermore, a plurality of operator terminals 10 can perform screen sharing, and therefore a plurality of operators are able to cooperate with each other and divide the operations among each other, when providing the remote support.

The present embodiment can be regarded as follows.

An information processing system 1 according to the present embodiment includes a plurality of user devices 12 each including an operation panel 602, and at least one operator terminal 10 including a display device 502. The at least one operator terminal 10 is able to communicate with the plurality of user devices 12 via a network N1. The information processing system 1 includes a first screen sharing unit 22 configured to cause sharing of display contents of the operation panel 602 of a user device 12A of the plurality of user devices 12 and the display device 502 of the at least one operator terminal 10; and a second screen sharing unit 23 configured to acquire, from the user device 12A, information of a user device 12B of the plurality of user devices 12 that is operating in cooperation with the user device 12A, and cause sharing of display contents of the operation panel 602 of the user device 12B and the display device 502 of the at least one operator terminal 10 based on the information of the user device 12B.

Furthermore, the second screen sharing unit 23 acquires an identification code of the user device 12B from the user device 12A, based on a request received by the at least one operator terminal 10.

Furthermore, the second screen sharing unit 23 acquires the identification code of the user device 12B from the user device 12A, when the user device 12A and the user device 12B execute device cooperation.

When a first operator terminal 10 of the at least one operator terminal 10 is sharing display contents with the user device 12B, and an abnormality occurs in the user device 12B, information indicating that the abnormality is occurring in the user device 12B is displayed on the display device 502 of the first operator terminal 10 and the operation panel 602 of the user device 12B.

The second screen sharing unit 23 receives, from an operator, a request to reset communication for resolving the abnormality of the user device 12B, when the abnormality is occurring in the user device 12B.

The information processing system 1 according to the present embodiment further includes a remote operation unit 26 configured to operate the user device 12B from the at least one operator terminal 10 that is sharing display contents with the user device 12B.

The user device 12A and the user device 12B output output data by performing device cooperation. One electronic device of the user device 12A and the user device 12B provides the output data to another electronic device, and the other user device outputs the output data provided from the one electronic device.

The first screen sharing unit 22 and the second screen sharing unit 23 cause sharing of a display content displayed by being projected by a projecting device of the user device 12A or the user device 12B and a display content of the display device 502 of the at least one operator terminal 10.

Furthermore, in the information processing system 1 according to the present embodiment, when a first operator terminal 10 of the at least one operator terminal 10 is sharing display contents with the user device 12B, and an abnormality occurs in the user device 12B, information indicating that the abnormality is occurring in the user device 12B is displayed on the display device 502 of the first operator terminal 10, the display device 502 of a second operator terminal 10 other than the first operator terminal 10, and the operation panel of the user device 12B.

Furthermore, the second screen sharing unit 23 acquires the identification code of the user device 12B from the user device 12A, based on a request received by one information processing apparatus of the operator terminals 10.

When one information processing apparatus of the operator terminals 10 is sharing display contents with the user device 12B, and an abnormality occurs in the user device 12B, information indicating that the abnormality is occurring in the user device 12B is displayed on the display device 502 of the one information processing apparatus of the operator terminals 10 and the operation panel 602 of the user device 12B.

The second screen sharing unit 23 receives, from one of the operators, a request to reset communication for resolving the abnormality of the user device 12B, when the abnormality is occurring in the user device 12B.

The information processing system 1 according to the present embodiment further includes a remote operation unit 26 configured to operate the user device 12B from one information processing apparatus of the operator terminals 10 that is sharing display contents with the user device 12B.

Furthermore, the information processing system 1 according to the present embodiment further includes a shared screen switching unit 24 configured to change the screen sharing from one information processing apparatus of the operator terminals 10 that is sharing display contents with the user device 12B, to another information processing apparatus.

The first screen sharing unit 22 and the second screen sharing unit 23 cause sharing of a display content displayed by being projected by the projecting device of the user device 12A or the user device 12B and a display content of the display device 502 of one information processing apparatus of the operator terminals 10.

Furthermore, the operator terminal 10 according to the present embodiment is an information processing apparatus that includes the display device 502. The operator terminal 10 is able to communicate, via a network N1, with a plurality of user devices 12 each including an operation panel 602. The operator terminal 10 includes a first screen sharing unit 22 configured to cause sharing of display contents of the operation panel 602 of a user device 12A of the plurality of user devices 12 and the display device 502 of the operator terminal 10; and a second screen sharing unit 23 configured to acquire, from the user device 12A, an identification code of a user device 12B of the plurality of user devices 12 that is operating in cooperation with the user device 12A, and cause sharing of display contents of the operation panel 602 of the user device 12B and the display device 502 of the operator terminal 10 based on the identification code of the user device 12B.

Furthermore, a program according to the present embodiment causes an operator terminal 10, which includes a display device 502 and which is able to communicate, via a network, with a plurality of user devices 12 each including an operation panel 602, to function as a first screen sharing unit 22 configured to cause sharing of display contents of the operation panel 602 of a user device 12A of the plurality of user devices 12 and the display device 502 of the operator terminal 10; and a second screen sharing unit 23 configured to acquire, from the user device 12A, an identification code of a user device 12B of the plurality of user devices 12 that is operating in cooperation with the user device 12A, and cause sharing of display contents of the operation panel 602 of the user device 12B and the display device 502 of the operator terminal 10 based on the identification code of the user device 12B.

According to one embodiment of the present invention, an information processing system and an information processing apparatus are provided, which are capable of reducing the load of the user, in the case of sharing display contents between a plurality of electronic devices and an information processing apparatus.

The information processing system and the information processing apparatus are not limited to the specific embodiments described herein, and variations and modifications may be made without departing from the spirit and scope of the present invention.

The present application is based on and claims the benefit of priority of Japanese Priority Patent Application No. 2014-108135, filed on May 26, 2014 and Japanese Priority Patent Application No. 2015-080594, filed on Apr. 10, 2015, the entire contents of which are hereby incorporated herein by reference.

What is claimed is:

1. An information processing system including a plurality of electronic devices each including a display unit, and at least one information processing apparatus including a display unit, the at least one information processing apparatus being able to communicate with the plurality of electronic devices via a network, the information processing system comprising:
a first sharing unit configured to cause sharing of display contents of the display unit of a first electronic device of the plurality of electronic devices and the display unit of the at least one information processing apparatus; and
a second sharing unit configured to acquire, from the first electronic device, information of a second electronic device of the plurality of electronic devices that is operating in cooperation with the first electronic device, and cause sharing of display contents of the display unit of the second electronic device and the display unit of the at least one information processing apparatus based on the information of the second electronic device.

2. The information processing system according to claim 1, wherein
the second sharing unit acquires the information of the second electronic device from the first electronic device, based on a request received by the at least one information processing apparatus.

3. The information processing system according to claim 1, wherein
the second sharing unit acquires the information of the second electronic device from the first electronic device, when the first electronic device and the second electronic device execute device cooperation.

4. The information processing system according to claim 1, wherein
when a first information processing apparatus of the at least one information processing apparatus is sharing display contents with the second electronic device, and an abnormality occurs in the second electronic device, information indicating that the abnormality is occurring in the second electronic device is displayed on the display unit of the first information processing apparatus and the display unit of the second electronic device.

5. The information processing system according to claim 4, wherein
the second sharing unit receives, from an operator of the first information processing apparatus, a request to perform a process of resolving the abnormality of the second electronic device, when the abnormality is occurring in the second electronic device.

6. The information processing system according to claim 1, further comprising:
a remote operation unit configured to operate the second electronic device from the at least one information processing apparatus that is sharing display contents with the second electronic device.

7. The information processing system according to claim 1, wherein
the first electronic device and the second electronic device output output data by performing device cooperation.

8. The information processing system according to claim 7, wherein
one electronic device of the first electronic device and the second electronic device provides the output data to another electronic device of the first electronic device and the second electronic device, and the other electronic device outputs the output data provided from the one electronic device.

9. The information processing system according to claim 1, wherein
the first sharing unit and the second sharing unit cause sharing of a display content displayed by being projected by the display unit of the first electronic device or the second electronic device and a display content of the display unit of the at least one information processing apparatus.

10. The information processing system according to claim 1, wherein
when a first information processing apparatus of the at least one information processing apparatus is sharing display contents with the second electronic device, and an abnormality occurs in the second electronic device, information indicating that the abnormality is occurring in the second electronic device is displayed on the display unit of the first information processing apparatus, the display unit of a second information processing apparatus other than the first information processing apparatus of the at least one information processing apparatus, and the display unit of the second electronic device.

11. The information processing system according to claim 10, wherein
the second sharing unit acquires the information of the second electronic device from the first electronic device, based on a request received by one of the first and second information processing apparatuses.

12. The information processing system according to claim 10, wherein
when one of the first and second information processing apparatuses is sharing display contents with the second electronic device, and an abnormality occurs in the second electronic device, information indicating that the abnormality is occurring in the second electronic device is displayed on the display unit of the one of the first and second information processing apparatuses and the display unit of the second electronic device, and the second sharing unit also causes sharing of display contents of the display unit of the second electronic device and the display unit of another one of the first and second information processing apparatuses.

13. The information processing system according to claim 12, wherein
the second sharing unit receives, from an operator of the one of the first and second information processing apparatuses and from an operator of the other one of the first and second information processing apparatuses, a request to perform a process of resolving the abnormality of the second electronic device, when the abnormality is occurring in the second electronic device.

14. The information processing system according to claim 10, further comprising:
a remote operation unit configured to operate the second electronic device from one of the first and second information processing apparatuses that is sharing display contents with the second electronic device.

15. The information processing system according to claim 10, further comprising:
a changing unit configured to change a remote operation unit operating the second electronic device from one of the first and second information processing apparatuses that is sharing display contents with the second electronic device, to the remote operation unit of another one of the first and second information processing apparatuses.

16. The information processing system according to claim 10, wherein
the first sharing unit and the second sharing unit cause sharing of a display content displayed by being projected by the display unit of the first electronic device or the second electronic device and a display content of the display unit of one of the first and second information processing apparatuses.

17. An information processing apparatus including a display unit, the information processing apparatus being able to communicate, via a network, with a plurality of electronic devices each including a display unit, the information processing apparatus comprising:
a first sharing unit configured to cause sharing of display contents of the display unit of a first electronic device of the plurality of electronic devices and the display unit of the information processing apparatus; and
a second sharing unit configured to acquire, from the first electronic device, information of a second electronic device of the plurality of electronic devices that is operating in cooperation with the first electronic device, and cause sharing of display contents of the display unit of the second electronic device and the display unit of the information processing apparatus based on the information of the second electronic device.

18. A non-transitory computer-readable recording medium storing a program that causes a computer to execute a process performed in an information processing apparatus including a display unit, the information processing apparatus being able to communicate, via a network, with a plurality of electronic devices each including a display unit, the process comprising:
causing sharing of display contents of the display unit of a first electronic device of the plurality of electronic devices and the display unit of the information processing apparatus; and
acquiring, from the first electronic device, information of a second electronic device of the plurality of electronic devices that is operating in cooperation with the first electronic device, and causing sharing of display contents of the display unit of the second electronic device and the display unit of the information processing apparatus based on the information of the second electronic device.
